(19) United States
(12) Patent Application Publication
(10) Pub. No.: US 2026/0141505 A1
(43) Pub. Date: May 21, 2026

(54) IMAGE RECOGNITION METHOD AND APPARATUS, STORAGE MEDIUM, AND ELECTRONIC DEVICE

(71) Applicant: TENCENT TECHNOLOGY (SHENZHEN) COMPANY LIMITED, Shenzhen (CN)

(72) Inventor: Jinlong PENG, Shenzhen (CN)

(21) Appl. No.: 19/452,211

(22) Filed: Jan. 16, 2026

Related U.S. Application Data
(63) Continuation of application No. PCT/CN2024/112262, filed on Aug. 15, 2024.

(30) Foreign Application Priority Data
Sep. 22, 2023 (CN) 202311239167.9

(51) Int. Cl. G06T 7/00; G06V 10/74; G06V 10/77; G06V 10/82; G06V 10/98

(52) U.S. Cl. CPC G06T 7/0004; G06V 10/761; G06V 10/7715; G06V 10/82; G06V 10/993; G06T 2207/30164

(57) ABSTRACT

This application discloses an image recognition method and apparatus, a storage medium, and an electronic device, applicable to various scenarios such as a cloud technology, artificial intelligence, intelligent transportation, and assisted driving. The method includes obtaining an image to be analyzed; extracting an image feature of the image to be analyzed by using an abnormal part recognition network having a twinned network structure, the image feature comprising a first image feature and a second image feature; obtaining a feature similarity between the first image feature and the second image feature; and determining a recognition result of the image to be analyzed based on the feature similarity, the recognition result indicating whether the part to be inspected in the image to be analyzed is an abnormal part.

### RELATED APPLICATIONS

This application is a continuation of PCT Application No. PCT/CN2024/112262 filed on Aug. 15, 2024, which claims priority to Chinese Patent Application No. 202311239167.9, filed with the China National Intellectual Property Administration on Sep. 22, 2023, and entitled “IMAGE RECOGNITION METHOD AND APPARATUS, STORAGE MEDIUM, AND ELECTRONIC DEVICE”, which are incorporated by reference in their entirety.

### FIELD OF THE TECHNOLOGY

This application relates to the computer field, and specifically, to image recognition technologies.

### BACKGROUND OF THE DISCLOSURE

In many industrial scenarios, to produce and assemble an industrial product, a large quantity of industrial parts usually need to be involved. However, in a mass production process of these industrial parts, due to a relatively small volume of these parts, many defective parts (also referred to as No Good (NG) products) with defects are inevitably produced. Therefore, these industrial parts usually need to be first checked for defects before being used.

Currently, a common defect detection method for an industrial part is: capturing an image of a part to be inspected and an image of a normal part (which may also be referred to as an OK product); then comparing features based on the images of the two parts; and if the similarity between the features of the two images is relatively high, recognizing the part to be inspected as an OK product; or if a similarity between the features of the two images is relatively low, recognizing the part to be inspected as an NG product.

However, when a defect on the part to be inspected is relatively small or relatively slight, a difference between the feature of the part to be inspected and the feature of the OK product may not be large, resulting in missing detection of the NG product. In other words, an image recognition method for an industrial part provided in the related art has a problem of low recognition accuracy.

### SUMMARY

Embodiments of this application provide an image recognition method and apparatus, a storage medium, and an electronic device, to at least solve a technical problem that accuracy of a recognition result of an existing image recognition manner for an industrial part is relatively low.

According to an aspect of embodiments of this application, an image recognition method is provided. The method is performed by an electronic device, and includes obtaining an image to be analyzed by performing image capture on a part to be inspected; extracting an image feature of the image to be analyzed by using an abnormal part recognition network having a twinned network structure, the image feature comprising a first image feature extracted from the image to be analyzed by a first feature extraction network in the twinned network structure, and a second image feature extracted from the image to be analyzed by a second feature extraction network in the twinned network structure, the first feature extraction network being obtained by performing training by using a positive sample image, the second feature extraction network being obtained by performing training with the first feature extraction network as a reference network by using a negative sample image, the positive sample image is a sample image that is in a sample image pair and that comprises a normal part, and the negative sample image is a sample image that is composited based on the positive sample image and that comprises an abnormal part; obtaining a feature similarity between the first image feature and the second image feature; and determining a recognition result of the image to be analyzed based on the feature similarity, the recognition result indicating whether the part to be inspected in the image to be analyzed is an abnormal part.

According to still another aspect of embodiments of this application, a non-transitory computer-readable storage medium is further provided. The computer-readable storage medium stores a computer program, and the computer program is configured for performing the image recognition method during running.

According to still another aspect of embodiments of this application, an electronic device is further provided, including a memory and a processor. The memory stores a computer program, and the processor is configured to perform the image recognition method by using the computer program.

In some embodiments of this application, the image to be analyzed obtained by performing image capture on the part to be inspected is obtained. Then, the image feature of the image to be analyzed is extracted by using the abnormal part recognition network having the twinned network structure, the image feature including the first image feature extracted from the image to be analyzed by the first feature extraction network in the twinned network structure, and the second image feature extracted from the image to be analyzed by the second feature extraction network in the twinned network structure, the first feature extraction network being obtained by performing training by using the positive sample image, the second feature extraction network being obtained by performing training with the first feature extraction network as the reference network by using the negative sample image, the positive sample image is the sample image that is in the sample image pair and that includes the normal part, and the negative sample image is the sample image that is composited based on the positive sample image and that includes the abnormal part. In a training process, an output of the second feature extraction network is made to be as close to an output of the first feature extraction network as possible, so that the second feature extraction network has some robustness to an abnormal defect, and the first feature extraction network as the reference network has no robustness to the abnormal defect. In this way, during recognition, whether the part to be inspected is an abnormal part may be determined by determining whether features outputted by the first feature extraction network and the second feature extraction network are similar. Specifically, the feature similarity between the first image feature and the second image feature is obtained. Further, the recognition result of the image to be analyzed is determined based on the feature similarity, the recognition result indicating whether the part to be inspected in the image to be analyzed is the abnormal part. To be specific, in some embodiments of this application, whether the part to be inspected has an abnormal defect is determined by using a similarity between features, which are respectively extracted from branch networks (namely, the first feature extraction network and the second feature extraction network) in the abnormal part recognition network, of the image to be analyzed corresponding to the part to be inspected. The recognition result of the image to be analyzed is not determined based only on a similarity between an image feature of an image corresponding to the part to be inspected and an image feature of an image corresponding to the normal part. Therefore, a technical problem in an existing technology that accuracy of a recognition result of an image recognition manner for an industrial part is relatively low is solved, thereby achieving a technical effect of improving accuracy of a recognition result of an image recognition manner for an industrial part.

### BRIEF DESCRIPTION OF THE DRAWINGS

The accompanying drawings herein are configured for providing a further understanding of this application and constitute a part of this application. Example embodiments of this application and the descriptions thereof are intended to explain this application, and do not constitute any limitation on this application. In the drawings:

FIG. 1 is an diagram of an application environment of an image recognition method according to an embodiment of this application.

FIG. 2 is an flowchart of an image recognition method according to an embodiment of this application.

FIG. 3 is an diagram of an image recognition method according to an embodiment of this application.

FIG. 4 is an diagram of an image recognition method according to an embodiment of this application.

FIG. 5 is an diagram of an image recognition method according to an embodiment of this application.

FIG. 6 is an diagram of an image recognition method according to an embodiment of this application.

FIG. 7 is an flowchart of an image recognition method according to an embodiment of this application.

FIG. 8 is an diagram of an image recognition method according to an embodiment of this application.

FIG. 9 is an diagram of an image recognition method according to an embodiment of this application.

FIG. 10 is an flowchart of an image recognition method according to an embodiment of this application.

FIG. 11 is an diagram of an image recognition method according to an embodiment of this application.

FIG. 12 is an flowchart of an image recognition method according to an embodiment of this application.

FIG. 13 is an flowchart of an image recognition method according to an embodiment of this application.

FIG. 14 is an diagram of a structure of an image recognition apparatus according to an embodiment of this application.

FIG. 15 is an diagram of a structure of an electronic device according to an embodiment of this application.

### DESCRIPTION OF EMBODIMENTS

To enable a person in the art to better understand the solutions of this application, the following clearly and completely describes the technical solutions in some embodiments of this application with reference to the accompanying drawings in some embodiments of this application. Apparently, the embodiments described are only some of embodiments of this application rather than all of embodiments. Based on embodiments of this application, all other embodiments obtained by a person of ordinary skill in the art without creative efforts fall within the protection scope of this application.

The specification, claims, and terms “first” and “second” of the foregoing accompanying drawings of this application are used to distinguish similar objects, but are unnecessarily used to describe a specific sequence or order. The data used in such a way is interchangeable in proper circumstances, so that some embodiments of this application described herein can be implemented in other sequences than the sequence illustrated or described herein. In addition, terms “include” and “have”, and their any variants are intended to cover the non-exclusive inclusion. For example, a process, method, system, product, or device that includes a series of operations or units is not necessarily limited to those operations or units expressly listed, but can include other operations or units not expressly listed or inherent to such a process, method, product, or device.

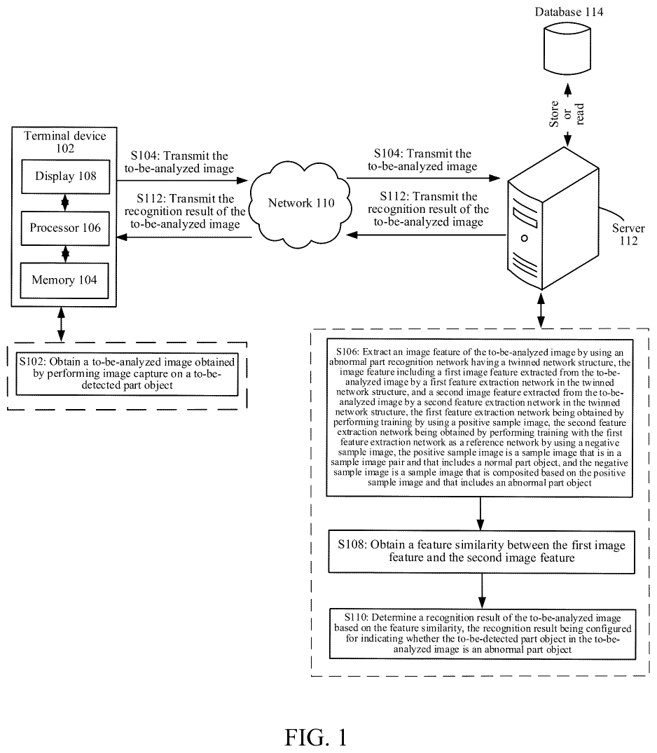

According to an aspect of embodiments of this application, an image recognition method is provided. In some embodiments, in an implementation, the image recognition method may be applied to, but is not limited, to an environment shown in FIG. 1. As shown in FIG. 1, a terminal device 102 includes: a memory 104, configured to store various data generated during operation of the terminal device 102; a processor 106, configured to process and calculate the foregoing data; and a display 108, configured to display a image to be analyzed. The terminal device 102 may exchange data with a server 112 over a network 110. The server 112 is connected to a database 114, and the database 114 is configured to store various data. The terminal device 102 may run a program application configured to perform recognition on the image to be analyzed.

A corresponding specific application process of the method in the environment shown in FIG. 1 is shown as the following operations:
S102 to S104 are performed: The terminal device 102 obtains an image to be analyzed obtained by performing image capture on a part to be inspected. The terminal device 102 transmits the image to be analyzed to the server 112 over the network 110.

Then, S106 to S110 are performed: When receiving the image to be analyzed, the server 112 extracts an image feature of the image to be analyzed by using an abnormal part recognition network having a twinned network structure, the image feature including a first image feature extracted from the image to be analyzed by a first feature extraction network in the twinned network structure, and a second image feature extracted from the image to be analyzed by a second feature extraction network in the twinned network structure, the first feature extraction network being obtained by performing training by using a positive sample image, the second feature extraction network being obtained by performing training with the first feature extraction network as a reference network by using a negative sample image, the positive sample image is a sample image that is in a sample image pair and that includes a normal part, and the negative sample image is a sample image that is composited based on the positive sample image and that includes an abnormal part. The server 112 obtains a feature similarity between the first image feature and the second image feature. The server 112 determines a recognition result of the image to be analyzed based on the feature similarity, the recognition result indicating whether the part to be inspected in the image to be analyzed is an abnormal part.

Next, S112 is performed: The server 112 sends the recognition result of the image to be analyzed to the terminal device 102 over the network 110.

In some embodiments of this application, the image to be analyzed obtained by performing image capture on the part to be inspected is obtained. Then, the image feature of the image to be analyzed is extracted by using the abnormal part recognition network having the twinned network structure, the image feature including the first image feature extracted from the image to be analyzed by the first feature extraction network in the twinned network structure, and the second image feature extracted from the image to be analyzed by the second feature extraction network in the twinned network structure, the first feature extraction network being obtained by performing training by using the positive sample image, the second feature extraction network being obtained by performing training with the first feature extraction network as the reference network by using the negative sample image, the positive sample image is the sample image that is in the sample image pair and that includes the normal part, and the negative sample image is the sample image that is composited based on the positive sample image and that includes the abnormal part. The feature similarity between the first image feature and the second image feature is obtained. Further, the recognition result of the image to be analyzed is determined based on the feature similarity, the recognition result indicating whether the part to be inspected in the image to be analyzed is the abnormal part. To be specific, in some embodiments of this application, whether the part to be inspected has an abnormal defect is determined by using a similarity between features, which are respectively extracted from branch networks (namely, the first feature extraction network and the second feature extraction network) in the abnormal part recognition network, of the image to be analyzed corresponding to the part to be inspected. The recognition result of the image to be analyzed is not determined based only on a similarity between an image feature of an image corresponding to the part to be inspected and an image feature of an image corresponding to the normal part. Therefore, a technical problem in an existing technology that accuracy of a recognition result of an image recognition manner for an industrial part is relatively low is solved, thereby achieving a technical effect of improving accuracy of a recognition result of an image recognition manner for an industrial part.

In some embodiments, the terminal device may be a terminal device configured with a client, and may include, but is not limited to, at least one of the following: a mobile phone (such as an Android mobile phone or an iOS mobile phone), a notebook computer, a tablet computer, a palmtop, a mobile Internet device (MID), a PAD, a desktop computer, an intelligent speech interaction device, a smart home appliance, and a vehicle-mounted terminal. The client may be a video client, an instant messaging client, a browser client, an education client, and the like. The network may include, but is not limited to, a wired network and a wireless network. The wired network includes: a local area network, a metropolitan area network, and a wide area network. The wireless network includes: Bluetooth, wireless fidelity (Wi-Fi), and another network implementing wireless communication. The server may be a single server, or may be a server cluster including a plurality of servers, or a cloud server. The foregoing is merely an example, and is not limited in some embodiments.

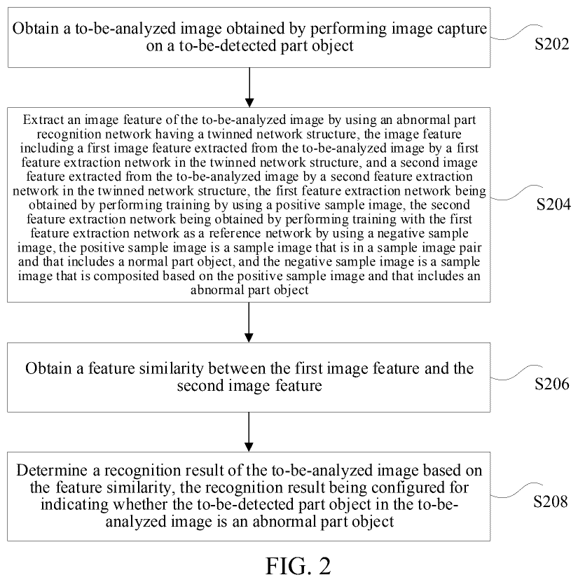

In one solution, as shown in FIG. 2, the image recognition method includes the following operations.
S202: Obtain an image to be analyzed obtained by performing image capture on a part to be inspected.

The image recognition method may be applied to, but is not limited to, an abnormality detection scenario of an industrial part. Specifically, the part to be inspected may be a part object for which whether an abnormal defect exists needs to be determined. The part to be inspected may be various parts that needs to be detected. When the image recognition method is applied to an abnormality detection scenario of an industrial part, the part to be inspected may be an industrial part. When the image recognition method is applied to an abnormality detection scenario of an automobile part, the part to be inspected may be an automobile part. When the image recognition method is applied to an abnormality detection scenario of a mechanical part, the part to be inspected may be a mechanical part. The image to be analyzed may be an image obtained by performing image capture on the part to be inspected, so that an image feature included in the image to be analyzed can be subsequently recognized by analyzing the image to be analyzed. A first image feature of the image to be analyzed corresponding to the part to be inspected is extracted by a first feature extraction network in an abnormal part recognition network, and a second image feature of the image to be analyzed corresponding to the part to be inspected is extracted by a second feature extraction network in the abnormal part recognition network. Therefore, whether the part to be inspected is an abnormal part is determined based on a feature similarity between the first image feature and the second image feature. In addition, the image recognition method may also be applied to classification or abnormality detection scenarios of any other part objects other than industrial parts. This is not limited in some embodiments.

It is assumed that the image recognition method is applied to an abnormality detection scenario of an industrial part. The part to be inspected may be configured for indicating, but is not limited to, the to-be-detected industrial part, for example, a thread, a gear, a chain, or a wheel. This is not limited in this application. The image to be analyzed obtained by performing image capture on the part to be inspected may be, but is not limited to, an image captured by photographing the to-be-detected industrial part at various angles.

In some embodiments, after the obtaining an image to be analyzed obtained by performing image capture on a part to be inspected, the method may include, but is not limited to: correcting a display position of the part to be inspected in the image to be analyzed by using a template image corresponding to the part to be inspected, to obtain a corrected image to be analyzed. The template image includes a reference part belonging to a same type of part as the part to be inspected.
S204: Extract an image feature of the image to be analyzed by using the abnormal part recognition network having a twinned network structure, the image feature including the first image feature extracted from the image to be analyzed by using the first feature extraction network in the twinned network structure, and the second image feature extracted from the image to be analyzed by using the second feature extraction network in the twinned network structure, the first feature extraction network being obtained by performing training by using a positive sample image, the second feature extraction network being obtained by performing training with the first feature extraction network as a reference network by using a negative sample image, the positive sample image is a sample image that is in a sample image pair and that includes a normal part, and the negative sample image is a sample image that is composited based on the positive sample image and that includes an abnormal part.

The twinned network structure is a type of neural network structure, and includes two or more totally same networks. The twinned network structure is often configured for solving a similarity-based task. In some embodiments of this application, the twinned network structure mainly refers to a pairwise structure.

The abnormal part recognition network having the twinned network structure may be configured for indicating, but is not limited to, a distilled neural network including a teacher network and a student network. A network structure of the initial student network is the same as that of the teacher network. Assuming that the abnormal part recognition network having the twinned network structure is the distilled neural network including the teacher network and the student network, the first feature extraction network may be configured for indicating, but is not limited to, the teacher network, and the second feature extraction network may be configured for indicating, but is not limited to, the student network. In a training process of the abnormal part recognition network (namely, the distilled neural network), feature extraction is performed on the positive sample image including the normal part by using the first feature extraction network (namely, the teacher network), to obtain a positive sample image feature. Then, the second feature extraction network (namely, the student network) is trained by using the negative sample image, and a parameter in the second feature extraction network (namely, the student network) is continuously adjusted, until a loss function between a negative sample image feature of the negative sample image extracted by the second feature extraction network (namely, the student network) and the positive sample image feature reaches a predetermined threshold. When the loss function between the negative sample image feature and the positive sample image feature reaches the predetermined threshold, it is determined that the abnormal part recognition network (namely, the distilled neural network) has been completely trained. An objective of training is to make an output of the second feature extraction network as close to an output of the first feature extraction network as possible, so that the second feature extraction network has some robustness to an abnormal defect, and the first feature extraction network as the reference network has no robustness to the abnormal defect.

Further, when the image to be analyzed is analyzed by using the abnormal part recognition network, the image to be analyzed may be inputted into the abnormal part recognition network (namely, the distilled neural network). If the image to be analyzed is a second type of image (namely, a normal image), image features outputted by the teacher network and the student network are relatively similar or even the same. If the image to be analyzed is a first type of image (namely, an abnormal image), an image feature outputted by the teacher network is similar to an image feature of a negative sample image, while an image feature outputted by the student network is more similar to an image feature of a positive sample image due to robustness of the student network. Therefore, the image features outputted by the two networks are greatly different. That is, if the image feature extracted by the first feature extraction network (namely, the teacher network) in the abnormal part recognition network (namely, the distilled neural network) is the same as the image feature extracted by the second feature extraction network (namely, the student network) in the abnormal part recognition network (namely, the distilled neural network), it indicates that a part object included in the image to be analyzed and a part object included in the positive sample image belong to a same type. Correspondingly, if the image feature extracted by the first feature extraction network (namely, the teacher network) is different from the image feature extracted by the second feature extraction network (namely, the student network), it indicates that the part object included in the to-be-detected image and a part object included in the negative sample image belong to a same type.

In some embodiments, the first feature extraction network may alternatively be obtained by performing training by using the positive sample image including the normal part in the sample image pair, and the second feature extraction network may alternatively be obtained by performing training by using the positive sample image and the negative sample image in the sample image pair. For example, assuming that the abnormal part recognition network having the twinned network structure is the distilled neural network including the teacher network and the student network, the first feature extraction network is the teacher network, and the second feature extraction network is the student network. A process of training the abnormal part recognition network (namely, the distilled neural network) includes the following operations: for the first feature extraction network (namely, the teacher network), inputting the positive sample image of the normal part into the first feature extraction network (namely, the teacher network), obtaining an image feature extracted by the first feature extraction network (namely, the teacher network) from the positive sample image, and comparing the image feature with an actual image feature of the positive sample image. The foregoing operations are continuously repeated, to continuously adjust a network parameter of the first feature extraction network (namely, the teacher network), until a loss function between the image feature extracted by the first feature extraction network (namely, the teacher network) from the positive sample image and the actual image feature of the positive sample image is less than a predetermined threshold. For the second feature extraction network (namely, the student network), the positive sample image of the normal part is inputted into the second feature extraction network (namely, the student network), an image feature extracted by the second feature extraction network (namely, the student network) from the positive sample image is obtained, and the image feature is compared with the image feature extracted by the trained first feature extraction network (namely, the teacher network) from the positive sample image. The negative sample image of the abnormal part is inputted into the second feature extraction network (namely, the student network), an image feature extracted by the second feature extraction network (namely, the student network) from the negative sample image is obtained, and the image feature is compared with the image feature extracted by the trained first feature extraction network (namely, the teacher network) from the negative sample image. The foregoing operations are continuously repeated, to continuously adjust a network parameter of the second feature extraction network (namely, the teacher network), until a loss function between the image feature extracted by the second feature extraction network (namely, the student network) from the positive sample image and the image feature extracted by the first feature extraction network (namely, the teacher network) from the positive sample image, and a loss function between the image feature extracted by the second feature extraction network (namely, the student network) from the negative sample image and the image feature extracted by the first feature extraction network (namely, the teacher network) from the negative sample image are less than a predetermined threshold.

It is assumed that the first feature extraction network is obtained by performing training by using the positive sample image including the normal part in the sample image pair, and the second feature extraction network is obtained by performing training by using the positive sample image and the negative sample image in the sample image pair. In some embodiments, before the obtaining an image to be analyzed obtained by performing image capture on a part to be inspected, the method further includes: S1: Obtain K positive sample images including the normal part and L negative sample images including the abnormal part, K being a natural number greater than 1, and L being a natural number greater than 1. S2: Train the initialized abnormal part recognition network by using the K positive sample images and the L negative sample images, until a comparison result between an output feature of the second feature extraction network and an output feature of the first feature extraction network satisfies a convergence condition.

In some embodiments, the training the initialized abnormal part recognition network by using the K positive sample images and the L negative sample images, until a comparison result between an output feature of the second feature extraction network and an output feature of the first feature extraction network satisfies a convergence condition may include: training the initialized abnormal part recognition network by using the K positive sample images and the L negative sample images, and adjusting a related parameter in the training of the abnormal part recognition network when the comparison result between the output feature of the second feature extraction network and the output feature of the first feature extraction network does not satisfy the convergence condition; and then, continuing to train the adjusted abnormal part recognition network, until the comparison result between the output feature of the second feature extraction network and the output feature of the first feature extraction network satisfies the convergence condition.

In some embodiments, the training the initialized abnormal part recognition network by using the K positive sample images and the L negative sample images, until a comparison result between an output feature of the second feature extraction network and an output feature of the first feature extraction network satisfies a convergence condition may include: training the first feature extraction network in the initialized abnormal part recognition network by using the K positive sample images, until a first sub-convergence condition is satisfied; and inputting the K positive sample images and the L negative sample images into the first feature extraction network satisfying the first sub-convergence condition and the second feature extraction network in the initialized abnormal part recognition network for training, until a second sub-convergence condition is satisfied, a first sample sub-image feature being obtained after the positive sample image is inputted into the first feature extraction network satisfying the first sub-convergence condition, a second sample sub-image feature being obtained after the positive sample image is inputted into the second feature extraction network, a third sample sub-image feature being obtained after the negative sample image is inputted into the first feature extraction network satisfying the first sub-convergence condition, and a fourth sample sub-image feature is obtained after the negative sample image is inputted into the second feature extraction network; and the second sub-convergence condition indicates that a feature similarity between the first sample sub-image feature and the second sample sub-image feature is greater than a seventh threshold, but a feature similarity between the third sample sub-image feature and the fourth sample sub-image feature is less than an eighth threshold.

The obtaining L negative sample images including the abnormal part may include, but is not limited to: obtaining the K positive sample images including the normal part; and adjusting L positive sample images obtained from the K positive sample images, to obtain the L negative sample images.

In some embodiments, the training the initialized abnormal part recognition network by using the K positive sample images and the L negative sample images, until a comparison result between an output feature of the second feature extraction network and an output feature of the first feature extraction network satisfies a convergence condition includes:
S1: Train the first feature extraction network in the initialized abnormal part recognition network by using the K positive sample images, until a first sub-convergence condition is satisfied. S2: Input the K positive sample images and the L negative sample images into the first feature extraction network satisfying the first sub-convergence condition and the second feature extraction network in the initialized abnormal part recognition network for training, until a second sub-convergence condition is satisfied, a first sample sub-image feature being obtained after the positive sample image is inputted into the first feature extraction network satisfying the first sub-convergence condition, a second sample sub-image feature being obtained after the positive sample image is inputted into the second feature extraction network, a third sample sub-image feature being obtained after the negative sample image is inputted into the first feature extraction network satisfying the first sub-convergence condition, and a fourth sample sub-image feature is obtained after the negative sample image is inputted into the second feature extraction network; and the second sub-convergence condition indicates that a feature similarity between the first sample sub-image feature and the second sample sub-image feature is greater than a seventh threshold, but a feature similarity between the third sample sub-image feature and the fourth sample sub-image feature is less than an eighth threshold.

The first sub-convergence condition may include, but is not limited to: a similarity between an image feature obtained after the positive sample image is inputted into the first feature extraction network and an actual image feature of the positive sample image is greater than a ninth threshold.

For example, the training the first feature extraction network in the initialized abnormal part recognition network by using the K positive sample images, until a first sub-convergence condition is satisfied may include, but is not limited to: sequentially using an i^{th} positive sample image in the K positive sample images as a current positive sample image, and performing the following operations until the first sub-convergence condition is satisfied: inputting the current positive sample image into the first feature extraction network, to obtain an image feature outputted by the first feature extraction network; obtaining a similarity between the image feature outputted by the first feature extraction network and an actual image feature of the positive sample image; and determining whether the similarity is greater than the ninth threshold, and stopping the training if the similarity is greater than the ninth threshold, or obtaining a next positive sample image as a current positive sample image, and repeatedly performing the foregoing operations if the similarity is less than the ninth threshold.

In some embodiments, the initialized first feature extraction network and the initialized second feature extraction network use a same network structure, and may use, but is not limited to: a deep convolutional neural network structure (for example, Residual Network-50 (ResNet-50)), a convolutional neural network model (for example, Vision Transformer (ViT)), a deep convolutional neural network model (for example, Visual Geometry Group 16 (VGG-16)) pre-trained model, and the like. This is not limited in some embodiments.

In one embodiment, the inputting the K positive sample images and the L negative sample images into the first feature extraction network satisfying the first sub-convergence condition and the second feature extraction network in the initialized abnormal part recognition network for training, until a second sub-convergence condition is satisfied may include, but is not limited to: sequentially using an i^{th} positive sample image in the K positive sample images as a current positive sample image and using an i^{th} negative sample image in the L negative sample images as a current negative sample image, and performing the following operations until the second sub-convergence condition is satisfied: separately inputting the current positive sample image and the current negative sample image into the first feature extraction network satisfying the first sub-convergence condition, to obtain a first sample sub-image feature and a third sample sub-image feature; separately inputting the current positive sample image and the current negative sample image into the second feature extraction network, to obtain a second sample sub-image feature and a fourth sample sub-image feature; determining whether a feature similarity between the first sample sub-image feature and the second sample sub-image feature is greater than the seventh threshold, and whether a feature similarity between the third sample sub-image feature and the fourth sample sub-image feature is less than the eighth threshold; and stopping the training when the feature similarity between the first sample sub-image feature and the second sample sub-image feature is greater than the seventh threshold, and the feature similarity between the third sample sub-image feature and the fourth sample sub-image feature is less than the eighth threshold.
S206: Obtain the feature similarity between the first image feature and the second image feature.
S208: Determine a recognition result of the image to be analyzed based on the feature similarity, the recognition result indicating whether the part to be inspected in the image to be analyzed is the abnormal part.

In some embodiments, the feature similarity between the first image feature and the second image feature may be determined by using, but is not limited to, a regression loss function. For example, the feature similarity between the first image feature and the second image feature is obtained by using a mean square error (L2 loss) regression loss function shown below:

$$Loss ( x , y ) = \frac{1}{n} {\sum }_{i = 1}^{n} {( {y}_{i} - f ( {x}_{i} ) )}^{2} \qquad ( 1 )$$

The parameter n in the foregoing function is a quantity of image feature dimensions corresponding to the image to be analyzed, the parameter xᵢ in the foregoing function is the first image feature in an i^{th} dimension corresponding to the image to be analyzed, and the parameter yᵢ in the foregoing function is the second image feature in the i^{th} dimension corresponding to the image to be analyzed. If a value of Loss (x, y) is greater than a particular threshold (for example, 0.5), it indicates that a difference between the first image feature and the second image feature is relatively large, and the feature similarity between the first image feature and the second image feature is relatively small, thereby determining that the part to be inspected in the image to be analyzed is the abnormal part. If the value of Loss (x, y) is less than or equal to 0.5, it indicates that the difference between the first image feature and the second image feature is relatively small, and the feature similarity between the first image feature and the second image feature is relatively large, thereby determining that the part to be inspected in the image to be analyzed is the normal part. The feature similarity between the first image feature and the second image feature may alternatively be determined by using another loss function. This is not limited in some embodiments.

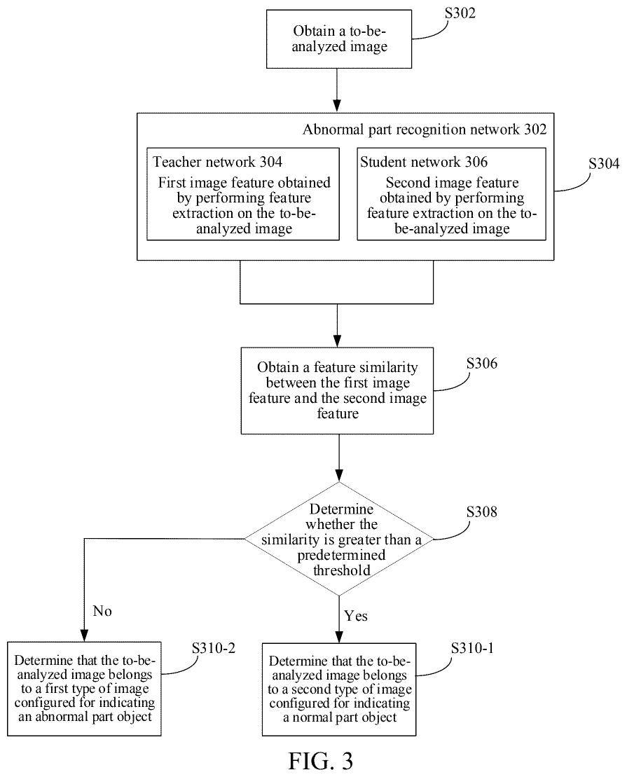

In one embodiment, it is assumed that the image recognition method is applied to an abnormality detection scenario of an industrial part. Assuming that the part to be inspected is a screw part, the image to be analyzed is a captured image including the screw part. The method is described by taking the following operations shown in FIG. 3 as an example:
S302 is performed: Obtain an image to be analyzed obtained by performing image capture on a screw part.

Then, S304 is performed: Extract a first image feature and a second image feature of the image to be analyzed by using an abnormal part recognition network 302 having a twinned network structure. Specifically, the first image feature is obtained by performing feature extraction on the image to be analyzed by using a teacher network 304 in the abnormal part recognition network, and the second image feature is obtained by performing feature extraction on the image to be analyzed by using a student network 306 in the abnormal part recognition network.

Further, S306 is performed: Compare the first image feature with the second image feature, to obtain a feature similarity between the first image feature and the second image feature.

Next, S308 is performed: Determine whether the similarity between the first image feature and the second image feature is greater than a predetermined threshold. S310-1 is performed when the similarity is greater than the predetermined threshold: Determine that the image to be analyzed belongs to a second type of image configured for indicating a normal part, and there is no defect in the screw part. S310-2 is performed when the similarity is not greater than the predetermined threshold: Determine that the image to be analyzed belongs to a first type of image configured for indicating an abnormal part, and there is a defect in the screw part.

An image feature extracted by the student network from a positive sample image and an image feature extracted by the first feature extraction network from the positive sample image are the same, and an image feature extracted by the student network from a negative sample image is different from an image feature extracted by the teacher network from the negative sample image.

In some embodiments of this application, the image to be analyzed obtained by performing image capture on the part to be inspected is obtained. Then, the image feature of the image to be analyzed is extracted by using the abnormal part recognition network having the twinned network structure, the image feature including the first image feature extracted from the image to be analyzed by the first feature extraction network in the twinned network structure, and the second image feature extracted from the image to be analyzed by the second feature extraction network in the twinned network structure, the first feature extraction network being obtained by performing training by using the positive sample image, the second feature extraction network being obtained by performing training with the first feature extraction network as the reference network by using the negative sample image, the positive sample image is the sample image that is in the sample image pair and that includes the normal part, and the negative sample image is the sample image that is composited based on the positive sample image and that includes the abnormal part. In a training process, an output of the second feature extraction network is made to be as close to an output of the first feature extraction network as possible, so that the second feature extraction network has some robustness to an abnormal defect, and the first feature extraction network as the reference network has no robustness to the abnormal defect. In this way, during recognition, whether the part to be inspected is an abnormal part may be determined by determining whether features outputted by the first feature extraction network and the second feature extraction network are similar. Specifically, the feature similarity between the first image feature and the second image feature is obtained. Further, the recognition result of the image to be analyzed is determined based on the feature similarity, the recognition result indicating whether the part to be inspected in the image to be analyzed is the abnormal part. To be specific, in some embodiments of this application, whether the part to be inspected has an abnormal defect is determined by using a similarity between features, which are respectively extracted from branch networks (namely, the first feature extraction network and the second feature extraction network) in the abnormal part recognition network, of the image to be analyzed corresponding to the part to be inspected. The recognition result of the image to be analyzed is not determined based only on a similarity between an image feature of an image corresponding to the part to be inspected and an image feature of an image corresponding to the normal part. Therefore, a technical problem in an existing technology that accuracy of a recognition result of an image recognition manner for an industrial part is relatively low is solved, thereby achieving a technical effect of improving accuracy of a recognition result of an image recognition manner for an industrial part.

In one embodiment, the determining a recognition result of the image to be analyzed based on the feature similarity includes:
when the feature similarity is less than or equal to a first threshold, determining that the part to be inspected is the abnormal part, and determining that the recognition result is that the image to be analyzed belongs to a first type of image configured for indicating an abnormal part; or
when the feature similarity is greater than or equal to a second threshold, determining that the part to be inspected is the normal part, and determining that the recognition result is that the image to be analyzed belongs to a second type of image configured for indicating a normal part,
the first threshold being less than the second threshold.

In some embodiments, the feature similarity may be obtained by using, but is not limited to, a loss function between the first image feature and the second image feature. A larger loss function value between the first image feature and the second image feature indicates a smaller feature similarity between the first image feature and the second image feature. Correspondingly, a smaller loss function value between the first image feature and the second image feature indicates a larger feature similarity between the first image feature and the second image feature.

In one embodiment, it is assumed that the similarity between the first image feature and the second image feature is 0.2. Assuming that the first threshold is 0.3, and the second threshold is 0.5, the method is described by taking the following operations as an example: comparing the first image feature with the second image feature, to obtain the feature similarity between the first image feature and the second image feature, namely, 0.2; and determining that the feature similarity (0.2) between the first image feature and the second image feature is less than the first threshold (0.3), and then determining that the recognition result is that the image to be analyzed belongs to the first type of image configured for indicating the abnormal part, that is, the part to be inspected is the abnormal part.

In another embodiment, it is still assumed that the similarity between the first image feature and the second image feature is 0.6. Assuming that the first threshold is 0.3, and the second threshold is 0.5, the method is described by taking the following operations as an example: comparing the first image feature with the second image feature, to obtain the feature similarity between the first image feature and the second image feature, namely, 0.6; and determining that the feature similarity (0.6) between the first image feature and the second image feature is greater than the second threshold (0.5), and then determining that the recognition result is that the image to be analyzed belongs to the second type of image configured for indicating the normal part, that is, the part to be inspected is the normal part.

In some embodiments of this application, when the feature similarity is less than or equal to the first threshold, it is determined that the part to be inspected is the abnormal part, and it is determined that the recognition result is that the image to be analyzed belongs to the first type of image configured for indicating the abnormal part; or when the feature similarity is greater than or equal to the second threshold, it is determined that the part to be inspected is the normal part, and it is determined that that the recognition result is that the image to be analyzed belongs to the second type of image configured for indicating the normal part, the first threshold being less than the second threshold. To be specific, in some embodiments of this application, whether the part to be inspected has an abnormal defect is determined by using a similarity between features, which are respectively extracted from branch networks (namely, the first feature extraction network and the second feature extraction network) in the abnormal part recognition network, of the image to be analyzed corresponding to the part to be inspected. The recognition result of the image to be analyzed is not determined based only on a similarity between an image feature of an image corresponding to the part to be inspected and an image feature of an image corresponding to the normal part. Therefore, a technical problem in an existing technology that accuracy of a recognition result of an image recognition manner for an industrial part is relatively low is solved, thereby achieving a technical effect of improving accuracy of a recognition result of an image recognition manner for an industrial part.

In some embodiments, in a solution, after the obtaining an image to be analyzed obtained by performing image capture on a part to be inspected, the method further includes:
S1: Obtain a template image corresponding to the part to be inspected, the template image including a reference part belonging to a same type of part as the part to be inspected, and the reference part being a normal part.

In some embodiments, the template image may be obtained based on, but is not limited to, the following operations: obtaining a detected absolutely normal part with no defect as the reference part, and then performing image capture on all image points of the reference part that need to be detected, to obtain the template image.
S2: Correct a display position of the part to be inspected in the image to be analyzed according to a display position of the reference part in the template image, to obtain a corrected image, the part to be inspected in the corrected image being in display alignment with the reference part in the template image.

The display position of the part to be inspected in the image to be analyzed may include, but is not limited to: a display direction, an angle, and a position of the part to be inspected in the image to be analyzed. The part to be inspected being in display alignment with the reference part in the template image may be configured for indicating, but is not limited to, that a display direction, an angle, and a position of the part to be inspected in the image to be analyzed are consistent with a display direction, an angle, and a position of the reference part in the template image. Further, the display position of the part to be inspected in the image to be analyzed may be corrected by using, but is not limited to, a transformation matrix between the image to be analyzed and the template image.

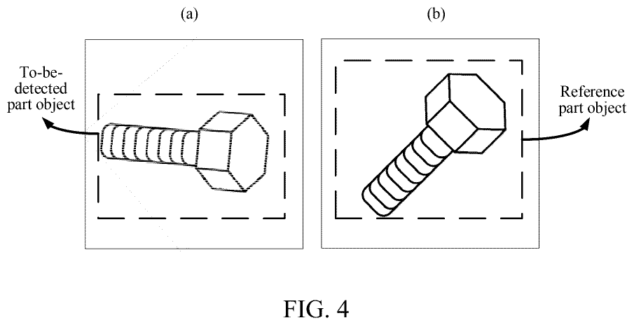

For example, it is assumed that an image shown in (a) in FIG. 4 is an image to be analyzed, a part to be inspected included in the image to be analyzed is a screw part, an image shown in (b) in FIG. 4 is a template image, and a reference part included in the template image is also a screw part. The correcting a display position of the part to be inspected in the image to be analyzed according to a display position of the reference part in the template image, to obtain a corrected image may include, but is not limited to: adjusting the part to be inspected in (a) in FIG. 4, so that a display direction, an angle, and a position of the part to be inspected are consistent with a display direction, an angle, and a position of the reference part in (b) in FIG. 4.

In some embodiments of this application, the template image corresponding to the part to be inspected is obtained, the template image including the reference part belonging to the same type of part as the part to be inspected, and the reference part being the normal part. Then, the display position of the part to be inspected in the image to be analyzed is corrected according to the display position of the reference part in the template image, to obtain the corrected image, the part to be inspected in the corrected image being in display alignment with the reference part in the template image. In other words, according to some embodiments of this application, the display position of the part to be inspected in the image to be analyzed is corrected by using the template image corresponding to the part to be inspected, so that the image to be analyzed is more standard, and further, the image feature of the image to be analyzed is more accurately extracted by using the abnormal part recognition network, thereby achieving a technical effect of improving accuracy of a recognition result of an image recognition manner for an industrial part.

In some embodiments, in a solution, the correcting a display position of the part to be inspected in the image to be analyzed according to a display position of the reference part in the template image, to obtain a corrected image includes:
S1: Perform edge detection processing on the reference part in the template image, to obtain a first object contour image, and perform edge detection processing on the part to be inspected in the image to be analyzed, to obtain a second object contour image.

The edge detection processing may be performed on the reference part in the template image and the part to be inspected in the image to be analyzed in a manner such as, but not limited to, a differentiation method, a differential edge detection method, a Roberts edge detection operator, a Sobel edge detection operator, and a Laplace edge detection operator. This is not limited in some embodiments.

The Roberts edge detection operator is to use a difference between two adjacent pixels in a diagonal direction according to a principle that a difference in any pair of perpendicular directions may be used to calculate a gradient; and then, calculate a Roberts gradient amplitude value. A Roberts detector is relatively simple, but has some functional limitations. For example, the Roberts detector is asymmetric, and cannot detect an edge of a multiple of 45°. However, the Roberts detector is simple and fast, and therefore is often configured for hardware implementation. The Sobel edge detection operator is to examine a weighted difference between grayscales of upper, lower, left, and right neighbors for each pixel in a digital image. The Laplace edge detection operator is a second-order differential operator, and differs from other edge detection methods in that the method is an isotropic detection method, that is, an edge enhancement degree thereof is irrelevant to an edge direction, so as to satisfy requirements on edge sharpening in different directions.
S2: Convert the first object contour image into a first object contour point set, and convert the second object contour image into a second object contour point set.

In some embodiments, the converting the first object contour image into a first object contour point set may include, but is not limited to: converting all key positions in the first object contour image into points in a first coordinate system by using a non-maximum suppression (NMS) algorithm, to obtain the first object contour point set. Correspondingly, the converting the second object contour image into a second object contour point set may include, but is not limited to: converting all key points in the second object contour image into points in a second coordinate system by using a non-maximum suppression (NMS) algorithm, to obtain the second object contour point set. The NMS algorithm is widely applied to conventional target detection algorithms of feature extraction and deep learning. A principle of the NMS algorithm is to obtain an optimal solution by obtaining a local maximum value through filtering. The NMS algorithm is used in two-dimensional edge extraction to screen out some points having a relatively small gradient direction change rate after an edge contour is extracted, to avoid interference. The NMS algorithm also plays an important role in three-dimensional key point detection, to filter out a non-local extreme value in a feature.

After the converting the first object contour image into a first object contour point set, and converting the second object contour image into a second object contour point set, the method may further include, but is not limited to: removing error points included in the first object contour point set and the second object contour point set.

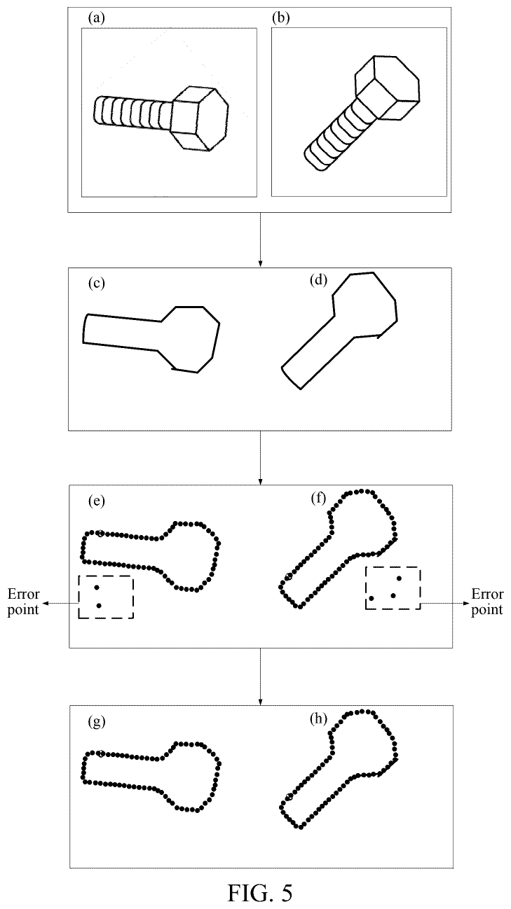

For example, it is assumed that an image shown in (a) in FIG. 5 is an image to be analyzed, a part to be inspected included in the image to be analyzed is a screw part, an image shown in (b) in FIG. 5 is a template image, and a reference part included in the template image is also a screw part. The performing edge detection processing on the reference part in the template image, to obtain a first object contour image, and performing edge detection processing on the part to be inspected in the image to be analyzed, to obtain a second object contour image may include, but is not limited to: performing edge detection processing on the part to be inspected in (a) in FIG. 5, to obtain a contour image of the part to be inspected (namely, the first object contour image) shown in (c) in FIG. 5; and performing edge detection processing on the reference part in (b) in FIG. 5, to obtain a contour image of the reference part (namely, the second object contour image) shown in (d) in FIG. 5.

Then, the converting the first object contour image into a first object contour point set, and converting the second object contour image into a second object contour point set may include, but is not limited to: converting the first object contour image of the reference part in (c) in FIG. 5 into a contour point set of the reference part (namely, the first object contour point set) shown in (e) in FIG. 5 by using the NMS algorithm, and converting the second object contour image of the part to be inspected in (d) in FIG. 5 into a contour point set of the part to be inspected (namely, the second object contour point set) shown in (f) in FIG. 5 by using the NMS algorithm;
then, deleting error points that do not belong to the reference part and that are in the contour point set of the reference part (namely, the first object contour point set) shown in (e) in FIG. 5, and deleting error points that do not belong to the part to be inspected and that are in the contour point set of the part to be inspected (namely, the second object contour point set) shown in (f) in FIG. 5; and obtaining a first object contour point set that does not have an error point shown in (g) in FIG. 5, and a second object contour point set that does not have an error point shown in (h) in FIG. 5.
S3: Determine a correction transformation matrix based on a point correspondence between the first object contour point set and the second object contour point set.

Before the determining a correction transformation matrix based on a point correspondence between the first object contour point set and the second object contour point set, the method may include, but is not limited to: determining a matching relationship between each point included in the first object contour point set and each point included in the second object contour point set by using a nearest neighbor search method. The nearest neighbor search is also referred to as a closest point search, and refers to an optimization problem of searching for a point in a scale space that is closest to a query point. The nearest neighbor search is widely applied to many fields, such as computer vision, information retrieval, data mining, machine learning, and large-scale learning, and is most widely applied to the field of computer vision, such as computer graphics, image retrieval, copy retrieval, object recognition, scene recognition, scene classification, posture evaluation, and feature matching.

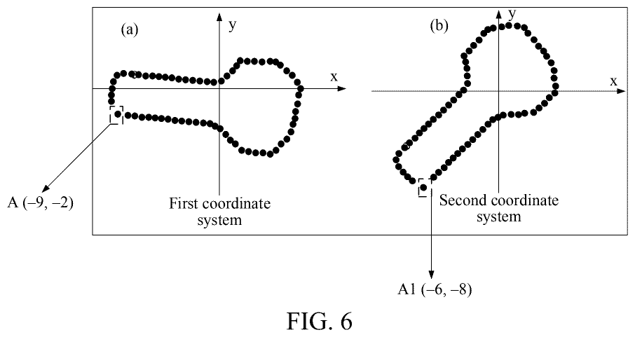

In some embodiments, it is assumed that a point set shown in (a) in FIG. 6 is the first object contour point set, and a point set shown in (b) in FIG. 6 is the second object contour point set. Taking a point A in the first object contour point set and a point A1 in the second object contour point set as an example, the method is described by taking the following operations as an example: separately determining coordinates of each point in the first object contour point set in a first coordinate system in which the first object contour point set is located, and separately determining coordinates of each point in the second object contour point set in a second coordinate system in which the second object contour point set is located, coordinates of the point A in the first object contour point set shown in (a) in FIG. 6 in the first coordinate system being (−9,−2), and coordinates of the point A1 in the second object contour point set shown in (b) in FIG. 6 in the second coordinate system being (−6,−8); and then, determining the matching relationship between each point in the first object contour point set and each point in the second object contour point set by using the nearest neighbor search method, the point A in the first object contour point set and the point A1 in the second object contour point set being both points at the tail of the screw part, and a matching relationship {(−9,−2), (−6,−8)} existing between the point A in the first object contour point set and the point A1 in the second object contour point set.

Further, the determining a correction transformation matrix based on a point correspondence between the first object contour point set and the second object contour point set may include, but is not limited to: determining the correction transformation matrix based on a machine vision (for example, Random Sample Consensus (ransac)) algorithm by using the point correspondence between the first object contour point set and the second object contour point set.
S4: Perform position correction on the second object contour point set in the image to be analyzed by using the correction transformation matrix, to obtain a corrected image including a third object contour point set, a display position of each contour point in the third object contour point set in the corrected image respectively corresponding to a display position of each contour point in the first object contour point set in the template image.

In some embodiments, the performing position correction on the second object contour point set in the image to be analyzed by using the correction transformation matrix, to obtain a corrected image including a third object contour point set may include, but is not limited to: multiplying the second object contour point set in the image to be analyzed by the correction transformation matrix, to obtain the corrected image including the third object contour point set.

In some embodiments of this application, the edge detection processing is performed on the reference part in the template image, to obtain the first object contour image, and the edge detection processing is performed on the part to be inspected in the image to be analyzed, to obtain the second object contour image. Then, the first object contour image is converted into the first object contour point set, and the second object contour image is converted into the second object contour point set. Further, the correction transformation matrix is determined based on the point correspondence between the first object contour point set and the second object contour point set. Next, the position correction is performed on the second object contour point set in the image to be analyzed by using the correction transformation matrix, to obtain the corrected image including the third object contour point set, the display position of each contour point in the third object contour point set in the corrected image respectively corresponding to the display position of each contour point in the first object contour point set in the template image. In other words, according to some embodiments of this application, the display position of the part to be inspected in the image to be analyzed is corrected by using the template image corresponding to the part to be inspected, so that the image to be analyzed is more standard, and further, the image feature of the image to be analyzed is more accurately extracted by using the abnormal part recognition network, thereby achieving a technical effect of improving accuracy of a recognition result of an image recognition manner for an industrial part.

In some embodiments, in a solution, the determining a correction transformation matrix based on a point correspondence between the first object contour point set and the second object contour point set includes:
S1: Determine a current transformation matrix to be estimated.
S2: Perform transformation processing on the second object contour point set by using the current transformation matrix, to obtain a reference contour point set.
S3: Determine a position error between a display position of each contour point in the reference contour point set and a display position of each contour point in the first object contour point set based on a point correspondence between each contour point in the first object contour point set and each contour point in the reference contour point set, to obtain a plurality of point errors.

After the determining a position error between a display position of each contour point in the reference contour point set and a display position of each contour point in the first object contour point set based on a point correspondence between each contour point in the first object contour point set and each contour point in the reference contour point set, to obtain a plurality of point errors, the method further includes: removing, from the reference contour point set, contour points whose point errors are greater than a fifth threshold, the fifth threshold being an integer greater than 0.
S4: Determine a transformation error between the reference contour point set and the first object contour point set by using the plurality of point errors.
S5: Adjust the current transformation matrix when the transformation error does not satisfy an error convergence condition, to obtain an adjusted transformation matrix, and perform transformation processing on the second object contour point set by using the adjusted transformation matrix.
S6: Determine the current transformation matrix as the correction transformation matrix when the transformation error satisfies the error convergence condition.

In some embodiments, the determining the current transformation matrix as the correction transformation matrix when the transformation error satisfies the error convergence condition may include, but is not limited to: determining the current transformation matrix as the correction transformation matrix when the transformation error is less than a sixth threshold for N consecutive times.

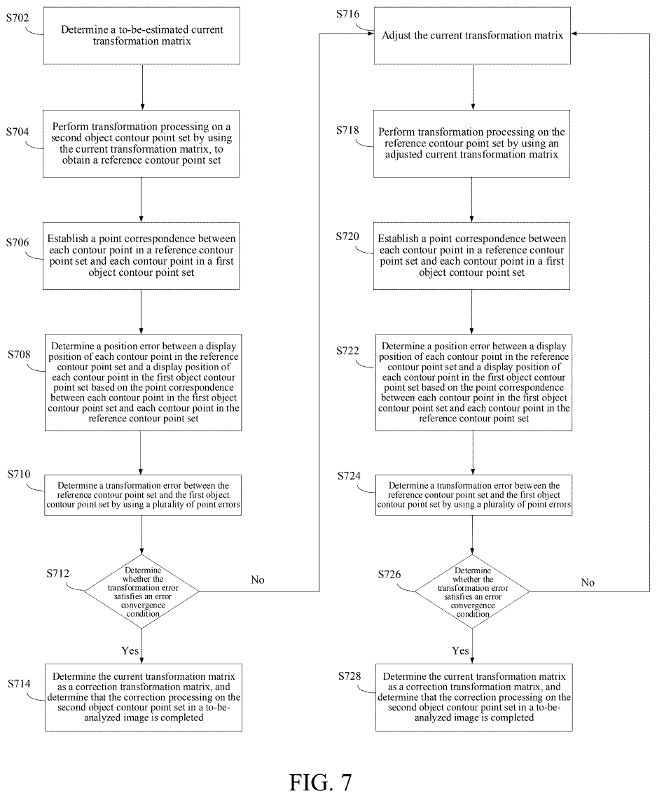

In one embodiment, the method is described by taking the following operations shown in FIG. 7 as an example:
S702 is performed: Determine a current transformation matrix to be estimated, the current transformation matrix being a random initialized transformation matrix.

Then, S704 is performed: Perform transformation processing on the second object contour point set by using the current transformation matrix, to obtain a reference contour point set.

Further, S706 is performed: Establish a point correspondence between each contour point in the reference contour point set and each contour point in the first object contour point set.

Next, S708 is performed: Determine a position error between a display position of each contour point in the reference contour point set and a display position of each contour point in the first object contour point set based on the point correspondence between each contour point in the first object contour point set and each contour point in the reference contour point set.

For example, assuming that the reference contour point set includes K contour points, and the first object contour point set includes K contour points, a position error between a k^{th} contour point in the reference contour point set and a k^{th} contour point in the first object contour point set is shown in Formula (2), and is a second-order Euclidean distance between the k^{th} contour point in the reference contour point set and the k^{th} contour point in the first object contour point set:

$${w}_{k} = ‖ {p}_{k} - {p}_{k}^{t} ‖ \qquad ( 2 )$$

wₖ is the position error between the k^{th} contour point in the reference contour point set and the k^{th} contour point in the first object contour point set. pₖ is coordinates of the k^{th} contour point in the reference contour point set in the second coordinate system, and pₖ^{t} is coordinates of the k^{th} contour point in the first object contour point set in the first coordinate system.

The point error between the k^{th} contour point in the reference contour point set and the k^{th} contour point in the first object contour point set is:

$${W}_{k} = \frac{{w}_{k}}{K} \qquad ( 3 )$$

Wₖ is the point error between the k^{th} contour point in the reference contour point set and the k^{th} contour point in the first object contour point set. K is a total quantity of contour points included in the reference contour point set, and is also a total quantity of contour points included in the first object contour point set. wₖ is the position error between the k^{th} contour point in the reference contour point set and the k^{th} contour point in the first object contour point set.

Further, S710 is performed: Determine a transformation error between the reference contour point set and the first object contour point set by using the plurality of point errors.

For example, still assuming that the reference contour point set includes K contour points, and the first object contour point set includes K contour points, the transformation error between the reference contour point set and the first object contour point set is:

$$F = {\sum }_{k = 1}^{K} {W}_{k} \qquad ( 4 )$$

F is the transformation error between the reference contour point set and the first object contour point set, and Wₖ is the point error between the k^{th} contour point in the reference contour point set and the k^{th} contour point in the first object contour point set.

Further, S712 is performed: Determine whether the transformation error satisfies an error convergence condition. For example, assuming that the transformation error between the reference contour point set and the first object contour point set is F, whether F is less than a sixth threshold is determined.

When the transformation error satisfies the error convergence condition, S714 is performed: Determine the current transformation matrix as the correction transformation matrix, and determine that the correction processing on the second object contour point set in the image to be analyzed is completed. If the transformation error does not satisfy the error convergence condition, S716 is performed: Adjust the current transformation matrix, and specifically, determine the adjusted transformation matrix based on the Ransac algorithm by using the point correspondence between the first object contour point set and the reference contour point set, and determine the adjusted transformation matrix as the current transformation matrix.

Then, S718 to S724 are performed: Perform transformation processing on the reference contour point set by using the adjusted current transformation matrix. Establish a point correspondence between each contour point in the reference contour point set and each contour point in the first object contour point set. Determine a position error between a display position of each contour point in the reference contour point set and a display position of each contour point in the first object contour point set based on the point correspondence between each contour point in the first object contour point set and each contour point in the reference contour point set. Determine a transformation error between the reference contour point set and the first object contour point set by using the plurality of point errors.

Further, S726 is performed: Determine whether the transformation error satisfies an error convergence condition. When the transformation error satisfies the error convergence condition, S728 is performed: Determine the current transformation matrix as the correction transformation matrix, and determine that the correction processing on the second object contour point set in the image to be analyzed is completed. S716 to S726 are repeatedly performed when the transformation error does not satisfy the error convergence condition, until the transformation error satisfies the error convergence condition.

In some embodiments of this application, the current transformation matrix to be estimated is determined. Then, the transformation processing is performed on the second object contour point set by using the current transformation matrix, to obtain the reference contour point set. Next, the position error between the display position of each contour point in the reference contour point set and the display position of each contour point in the first object contour point set is determined based on the point correspondence between each contour point in the first object contour point set and each contour point in the reference contour point set, to obtain the plurality of point errors. Further, the transformation error between the reference contour point set and the first object contour point set is determined by using the plurality of point errors. Then, the current transformation matrix is adjusted when the transformation error does not satisfy the error convergence condition, to obtain the adjusted transformation matrix, and the transformation processing is performed on the second object contour point set by using the adjusted transformation matrix. The current transformation matrix is determined as the correction transformation matrix when the transformation error satisfies the error convergence condition. In other words, according to some embodiments of this application, the display position of the part to be inspected in the image to be analyzed is corrected by using the template image corresponding to the part to be inspected, so that the image to be analyzed is more standard, and further, the image feature of the image to be analyzed is more accurately extracted by using the abnormal part recognition network, thereby achieving a technical effect of improving accuracy of a recognition result of an image recognition manner for an industrial part.

In some embodiments, in a solution, the extracting an image feature of the image to be analyzed by using an abnormal part recognition network having a twinned network structure includes:
S1: Perform area division on the image to be analyzed, to obtain N image to be analyzed blocks, N being a positive integer greater than 1.
S2: Perform feature extraction on the N image to be analyzed blocks by using the abnormal part recognition network, to obtain the image feature.

In some embodiments, the performing area division on the image to be analyzed, to obtain N image to be analyzed blocks includes one of the following: dividing the image to be analyzed according to a preset size, to obtain N image blocks having the same size, and determining the N image blocks as the N image to be analyzed blocks; and clipping N key image blocks from the image to be analyzed, the key image block being an image block that is in the image to be analyzed and in which a key object part of the part to be inspected is located, and determining the N key image blocks as the N image to be analyzed blocks.

Further, the performing feature extraction on the N image to be analyzed blocks by using the abnormal part recognition network, to obtain the image feature may include, but is not limited to: sequentially determining each of the N image to be analyzed blocks as a current image block, and performing the following operations: inputting the current image block into the first feature extraction network, to obtain a first current sub-image feature, and inputting the current image block into the second feature extraction network, to obtain a second current sub-image feature, the first image feature including the first current sub-image feature, and the second image feature including the second current sub-image feature.

In some embodiments of this application, the area division is performed on the image to be analyzed, to obtain the N image to be analyzed blocks, N being a positive integer greater than 1. Then, the feature extraction is performed on the N image to be analyzed blocks by using the abnormal part recognition network, to obtain the image feature. In other words, according to some embodiments of this application, the area division is performed on the image to be analyzed, to obtain the N image to be analyzed blocks, so that when the feature extraction is performed on the N image to be analyzed blocks by using the abnormal part recognition network, to obtain the image feature, as long as a problem is detected in one of the N image to be analyzed blocks, it can be determined that the part to be inspected is the abnormal part, thereby achieving a technical effect of improving recognition efficiency of image recognition. Further, the area division is performed on the image to be analyzed, to obtain the N image to be analyzed blocks, so that when the feature extraction is performed on the N image to be analyzed blocks by using the abnormal part recognition network, to obtain the image feature, as long as a problem is detected in one of the N image to be analyzed blocks, an abnormal position of the to-be-detected abnormal part can be quickly located, thereby making it easier to repair the to-be-detected abnormal part.

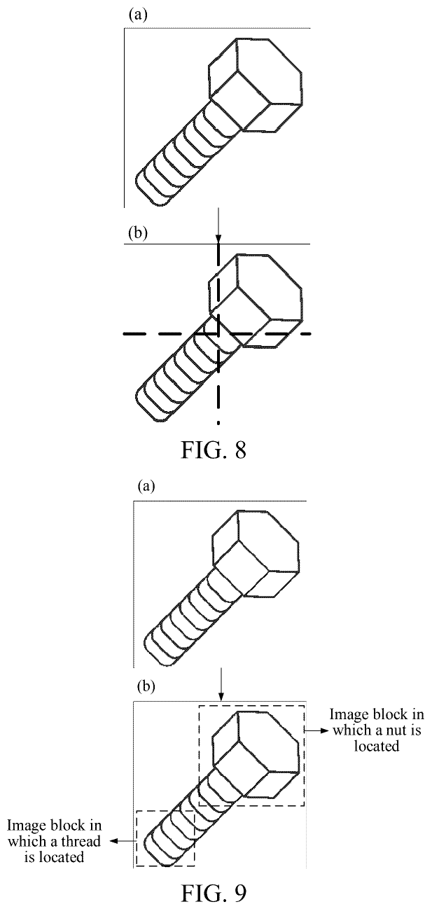

In some embodiments, in a solution, the performing area division on the image to be analyzed, to obtain N image to be analyzed blocks includes one of the following:
dividing the image to be analyzed according to a preset size, to obtain N image blocks having the same size, and determining the N image blocks as the N image to be analyzed blocks,
for example, it being assumed that the image to be analyzed is an image shown in (a) in FIG. 8, and the image to be analyzed is divided according to the preset size shown in (b) in FIG. 8, to obtain four image to be analyzed blocks having the same size; and
clipping N key image blocks from the image to be analyzed, the key image block being an image block that is in the image to be analyzed and in which a key object part of the part to be inspected is located, and determining the N key image blocks as the N image to be analyzed blocks.

In some embodiments, the key object part of the part to be inspected may be configured for indicating, but is not limited to, a part on the part to be inspected on which whether a defect exists needs to be detected, for example, a nut and a thread on the screw part.

In one embodiment, assuming that the image to be analyzed is an image shown in (a) in FIG. 9, the method is described by taking the following operations as an example: determining that the part to be inspected included in the image to be analyzed is a screw part, and determining that a nut and a thread tail on the screw part need to be detected, as shown in (a) in FIG. 9; and then, clipping two key image blocks shown in (b) in FIG. 9, namely, an image block in which the nut is located and a block in which the threaded tail is located from the image to be analyzed, as shown in (b) in FIG. 9.

In some embodiments of this application, the image to be analyzed is divided according to the preset size, to obtain the N image blocks having the same size, and the N image blocks are determined as the N image to be analyzed blocks, so that when the feature extraction is performed on the N image to be analyzed blocks by using the abnormal part recognition network, to obtain the image feature, as long as a problem is detected in one of the N image to be analyzed blocks, it can be determined that the part to be inspected is the abnormal part, thereby improving recognition efficiency of image recognition. The N key image blocks are clipped from the image to be analyzed, the key image block being the image block that is in the image to be analyzed and in which the key object part of the part to be inspected is located, and the N key image blocks are determined as the N image to be analyzed blocks, thereby reducing data that needs to be processed by the abnormal part recognition network, and further improving recognition efficiency of image recognition.

In some embodiments, in a solution, the performing feature extraction on the N image to be analyzed blocks by using the abnormal part recognition network, to obtain the image feature includes:
sequentially determining each of the N image to be analyzed blocks as a current image block, and performing the following operations:
inputting the current image block into the first feature extraction network, to obtain a first current sub-image feature, and inputting the current image block into the second feature extraction network, to obtain a second current sub-image feature, the first image feature including the first current sub-image feature, and the second image feature including the second current sub-image feature.

In one embodiment, it is assumed that the N image to be analyzed blocks include an image to be analyzed block A, an image to be analyzed block B, and an image to be analyzed block C. When the part to be inspected in the image to be analyzed is the normal part, the method is described by taking the following operations an example:
inputting the image to be analyzed block A into the first feature extraction network, to obtain a first sub-image feature A1, and inputting the image to be analyzed block A into the second feature extraction network, to obtain a second sub-image feature A2; obtaining a feature similarity between the first sub-image feature A1 and the first sub-image feature A2, to determine that the feature similarity is greater than the second threshold; inputting the image to be analyzed block B into the first feature extraction network, to obtain a first sub-image feature B1, and inputting the image to be analyzed block B into the second feature extraction network, to obtain a second sub-image feature B2; obtaining a feature similarity between the first sub-image feature B1 and the first sub-image feature B2, to determine that the feature similarity is greater than the second threshold; inputting the image to be analyzed block C into the first feature extraction network, to obtain a first sub-image feature C1, and inputting the image to be analyzed block C into the second feature extraction network, to obtain a second sub-image feature C2; obtaining a feature similarity between the first sub-image feature C1 and the first sub-image feature C2, to determine that the feature similarity is greater than the second threshold; and determining that the part to be inspected in the image to be analyzed is the normal part.

In another embodiment, it is still assumed that the N image to be analyzed blocks include an image to be analyzed block A, an image to be analyzed block B, and an image to be analyzed block C. When the part to be inspected in the image to be analyzed is the abnormal part and an abnormal area is located at a position corresponding to the image to be analyzed block B, the method is described by taking the following operations an example:
inputting the image to be analyzed block A into the first feature extraction network, to obtain a first sub-image feature A1, and inputting the image to be analyzed block A into the second feature extraction network, to obtain a second sub-image feature A2; obtaining a feature similarity between the first sub-image feature A1 and the first sub-image feature A2, to determine that the feature similarity is greater than the second threshold; inputting the image to be analyzed block B into the first feature extraction network, to obtain a first sub-image feature B1, and inputting the image to be analyzed block B into the second feature extraction network, to obtain a second sub-image feature B2; obtaining a feature similarity between the first sub-image feature B1 and the first sub-image feature B2, to determine that the feature similarity is less than the first threshold, that is, the part to be inspected in the image to be analyzed is the abnormal part; inputting the image to be analyzed block C into the first feature extraction network, to obtain a first sub-image feature C1, and inputting the image to be analyzed block C into the second feature extraction network, to obtain a second sub-image feature C2; obtaining a feature similarity between the first sub-image feature C1 and the first sub-image feature C2, to determine that the feature similarity is greater than the second threshold; and determining that the part to be inspected in the image to be analyzed is the abnormal part, and the abnormal area of the abnormal part is located at the position corresponding to the image to be analyzed block B.

In some embodiments of this application, each of the N image to be analyzed blocks is sequentially determined as the current image block, and the following operations are performed: inputting the current image block into the first feature extraction network, to obtain the first current sub-image feature, and inputting the current image block into the second feature extraction network, to obtain the second current sub-image feature, the first image feature including the first current sub-image feature, and the second image feature including the second current sub-image feature. In other words, according to some embodiments of this application, the area division is performed on the image to be analyzed, to obtain the N image to be analyzed blocks, so that when the feature extraction is performed on the N image to be analyzed blocks by using the abnormal part recognition network, to obtain the image feature, as long as a problem is detected in one of the N image to be analyzed blocks, it can be determined that the part to be inspected is the abnormal part, thereby achieving a technical effect of improving recognition efficiency of image recognition. Further, the area division is performed on the image to be analyzed, to obtain the N image to be analyzed blocks, so that when the feature extraction is performed on the N image to be analyzed blocks by using the abnormal part recognition network, to obtain the image feature, as long as a problem is detected in one of the N image to be analyzed blocks, an abnormal position of the to-be-detected abnormal part can be quickly located, thereby making it easier to repair the to-be-detected abnormal part.

In some embodiments, in a solution, before the obtaining an image to be analyzed obtained by performing image capture on a part to be inspected, the method further includes:
S1: Obtain K positive sample images including the normal part and K negative sample images including the abnormal part, to obtain K sample image pairs, the negative sample images being composited by adjusting the positive sample images, and K being a natural number greater than 1.

In some embodiments, before the obtaining K positive sample images including the normal part and K negative sample images including the abnormal part, to obtain K sample image pairs, the method may include, but is not limited to: sequentially correcting display positions of part objects respectively included in the K positive sample images including the normal part, and composing the K negative sample images including the abnormal part based on the K positive sample images including the normal part. For a specific method for correcting the display position, refer to the foregoing embodiment related to correcting the display position of the part to be inspected in the image to be analyzed. Details are not described in some embodiments.
S2: Train the initialized abnormal part recognition network by using the K sample image pairs, until a comparison result between an output feature of the second feature extraction network and an output feature of the first feature extraction network satisfies a convergence condition.

In some embodiments, the training the initialized abnormal part recognition network by using the K sample image pairs, until a comparison result between an output feature of the second feature extraction network and an output feature of the first feature extraction network satisfies a convergence condition may include: training the initialized abnormal part recognition network by using the K positive sample images and the K negative sample images. In a training process, a parameter in the first feature extraction network is fixed, output features of the first feature extraction network for the K positive sample images including the normal part affect training of the second feature extraction network, and a network parameter in the second feature extraction network is continuously adjusted, so that the comparison result between the output feature of the second feature extraction network and the output feature of the first feature extraction network satisfies the convergence condition. Assuming that the parameter in the first feature extraction network is fixed, that the comparison result between the output feature of the second feature extraction network and the output feature of the first feature extraction network satisfies the convergence condition may include, but is not limited to: a similarity between a first sample sub-image feature obtained after the positive sample image is inputted into the first feature extraction network and a second sample sub-image feature obtained after the positive sample image is inputted into the second feature extraction network is greater than a third threshold, but a feature similarity between a third sample sub-image feature obtained after the negative sample image is inputted into the first feature extraction network and a fourth sample sub-image feature obtained after the negative sample image is inputted into the second feature extraction network is less than a fourth threshold.

In some embodiments of this application, the K positive sample images including the normal part and the K negative sample images including the abnormal part are obtained, to obtain the K sample image pairs, the negative sample images being composited by adjusting the positive sample images, and K being a natural number greater than 1. Then, the initialized abnormal part recognition network is trained by using the K sample image pairs, until the comparison result between the output feature of the second feature extraction network and the output feature of the first feature extraction network satisfies the convergence condition. In other words, according to some embodiments of this application, the abnormal part recognition network is trained by using rich sample data, to improve precision of the abnormal part recognition network, thereby achieving a technical effect of improving accuracy of a recognition result of an image recognition manner for an industrial part.

In some embodiments, in a solution, the training the initialized abnormal part recognition network by using the K sample image pairs, until a comparison result between an output feature of the second feature extraction network and an output feature of the first feature extraction network reaches a convergence condition includes:
obtaining a current sample image pair from the K sample image pairs, and performing the following operations:
S1: Input a current positive sample image in the current sample image pair into the first feature extraction network, to obtain a current positive sample sub-image feature, and input a current negative sample image in the current sample image pair into the second feature extraction network, to obtain a current negative sample sub-image feature.
S2: Obtain a next sample image pair as the current sample image pair when a feature similarity between the current negative sample sub-image feature and the current positive sample sub-image feature is less than a third threshold.
S3: Add one to a training convergence statistics result when the feature similarity between the current negative sample sub-image feature and the current positive sample sub-image feature is greater than or equal to the third threshold.
S4: Determine that the convergence condition is satisfied when the training convergence statistics result reaches a fourth threshold.

In some embodiments, the initialized first feature extraction network and the initialized second feature extraction network use a same network structure, and may use, but is not limited to: a deep convolutional neural network structure (for example, Residual Network-50 (ResNet-50)), a convolutional neural network model (for example, Vision Transformer (ViT)), a deep convolutional neural network model (for example, Visual Geometry Group 16 (VGG-16)) pre-trained model, and the like. This is not limited in some embodiments.

In some embodiments, the convergence statistics result is configured for counting a quantity of times that the feature similarity between the current negative sample sub-image feature and the current positive sample sub-image feature is greater than or equal to the third threshold. When the quantity of times reaches the fourth threshold, it is determined that the abnormal part recognition network is sufficiently reliable, and the training is ended.

In some embodiments, before the inputting a current positive sample image in the current sample image pair into the first feature extraction network, and inputting a current negative sample image in the current sample image pair into the second feature extraction network, the method may include, but is not limited to: performing image block division on the current positive sample image, to obtain N current positive sample image blocks; and performing image block division on the current negative sample image, to obtain N current negative sample image blocks. For a specific image block division method, refer to the foregoing embodiment related to performing image block division on the image to be analyzed. Details are not described in some embodiments.

Correspondingly, the inputting a current positive sample image in the current sample image pair into the first feature extraction network, and inputting a current negative sample image in the current sample image pair into the second feature extraction network may include, but is not limited to: inputting the N current positive sample image blocks corresponding to the current positive sample image into the first feature extraction network, and inputting the N current negative sample image blocks corresponding to the current negative sample image into the second feature extraction network, N being a positive integer.

Further, the adding one to a training convergence statistics result when the feature similarity between the current negative sample sub-image feature and the current positive sample sub-image feature is greater than or equal to the third threshold; and determining that the convergence condition is satisfied when the training convergence statistics result reaches a fourth threshold may include, but is not limited to: adding one to the training convergence statistics result when a feature similarity between an image feature obtained after each of the N current positive sample image blocks is inputted into the first feature extraction network and an image feature obtained after each of the N current negative sample image blocks is inputted into the second feature extraction network is greater than or equal to the third threshold; and determining that the convergence condition is satisfied when the training convergence statistics result reaches the fourth threshold.

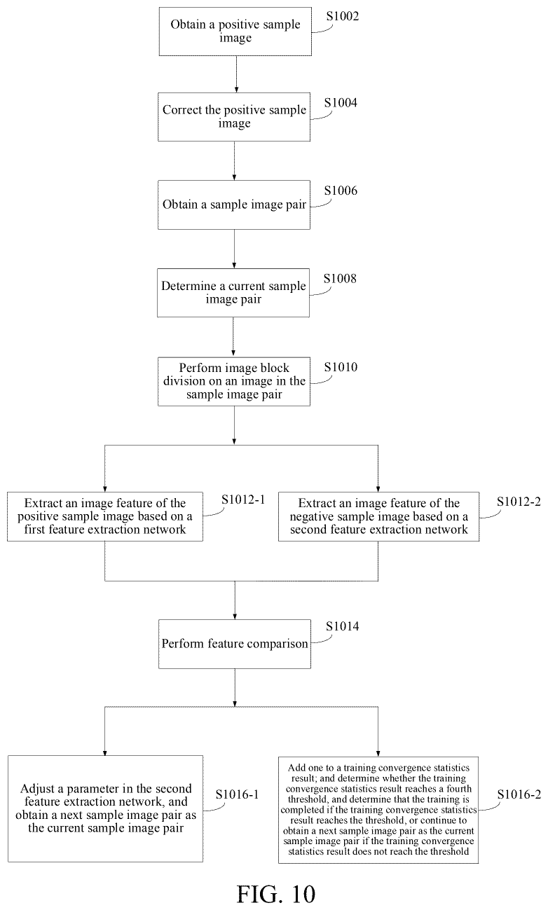

In one embodiment, the method is described by taking the following operations shown in FIG. 10 as an example:
S1002: Obtain a positive sample image.

Specifically, K positive sample images including a normal part are obtained.
S1004: Correct the positive sample image.

Specifically, a display position of a part object included in each of the K positive sample images is corrected.
S1006: Obtain a sample image pair.

Specifically, the K positive sample images are sequentially adjusted to composite K negative sample images including an abnormal part. K sample image pairs are generated, each sample image pair including one positive sample image and a negative sample image composited by using the positive sample image.
S1008: Determine a current sample image pair.

Specifically, an i^{th} sample image pair in the K sample image pairs is determined as the current sample image pair, i being a positive integer less than K.
S1010: Perform image block division on an image in the sample image pair.

Specifically, the positive sample image in the current sample image pair is divided into N positive sample image blocks, and the negative sample image in the current sample image pair is also divided into N negative sample image blocks respectively corresponding to the N positive sample image blocks in the positive sample image (for example, if the N positive sample image blocks in the positive sample image are thread blocks and nut blocks, the N negative sample image blocks in the negative sample image also need to be thread blocks and nut blocks).
S1012-1: Extract an image feature of the positive sample image based on a first feature extraction network.

Specifically, the N positive sample image blocks are sequentially inputted into the first feature extraction network, to obtain N positive sample image block features.
S1012-2: Extract an image feature of the negative sample image based on a second feature extraction network.

Specifically, the N negative sample image blocks are sequentially inputted into the second feature extraction network, to obtain N negative sample image block features.
S1014: Perform feature comparison.

Specifically, feature similarities between the N positive sample image block features and the N negative sample image block features are respectively compared.

After the N positive sample image block features are respectively compared with the N negative sample image block features, it is determined that there is a positive sample image block feature and a negative sample image block feature whose similarity is less than a third threshold. In this case, S1016-1 is performed: Adjust a parameter in the second feature extraction network, and obtain a next sample image pair as the current sample image pair.

After the N positive sample image block features obtained after the N positive sample image blocks are inputted into the first feature extraction network are respectively compared with the N negative sample image block features obtained after the N negative sample image blocks are inputted into the second feature extraction network, it is determined that the similarities between the N positive sample image block features and the similarities between the N negative sample image block features are all greater than or equal to the third threshold. In this case, S1016-2 is performed: Add one to a training convergence statistics result; and determine whether the training convergence statistics result reaches a fourth threshold, and determine that the training is completed if the training convergence statistics result reaches the threshold, or continue to obtain a next sample image pair as the current sample image pair if the training convergence statistics result does not reach the threshold.

In some embodiments of this application, the current sample image pair is obtained from the K sample image pairs, and the following operations are performed: inputting the current positive sample image in the current sample image pair into the first feature extraction network, and inputting the current negative sample image in the current sample image pair into the second feature extraction network; obtaining the next sample image pair as the current sample image pair when the feature similarity between the current negative sample sub-image feature and the current positive sample sub-image feature is less than the third threshold; adding one to the training convergence statistics result when the feature similarity between the current negative sample sub-image feature and the current positive sample sub-image feature is greater than or equal to the third threshold; and determining that the convergence condition is satisfied when the training convergence statistics result reaches the fourth threshold. Therefore, it is ensured that, when the part object is the normal part, the image feature extracted by the first feature extraction network from the image corresponding to the part object is the same as the image feature extracted by the second feature extraction network from the image corresponding to the part object; and when the part object is the abnormal part, the image feature extracted by the first feature extraction network from the image corresponding to the part object is different from the image feature extracted by the second feature extraction network from the image corresponding to the part object, so as to ensure accuracy of a recognition result of the image to be analyzed, thereby achieving a technical effect of improving accuracy of a recognition result of an image recognition manner for an industrial part.

In some embodiments, the obtaining K positive sample images including the normal part and K negative sample images including the abnormal part, to obtain K sample image pairs includes:
S1: Obtain the K positive sample images including the normal part.
S2: Adjust the K positive sample images, to composite the K negative sample images, the positive sample images being sample template images including the normal part.

In some embodiments, the adjusting the K positive sample images, to composite the K negative sample images may include, but is not limited to one of the following:
(1) adding white noise to the positive sample images, to generate the negative sample images;
(2) obtaining a plurality of abnormal part image blocks, the abnormal part image blocks including a part defect belonging to a same type of part as the part to be inspected, and covering the positive sample images with one or at least two of the plurality of abnormal part image blocks, to generate the negative sample images; and
(3) inputting the positive sample images into an abnormal part generation network, to obtain the negative sample images, the abnormal part generation network being a network that is obtained by performing training by using the positive sample images and the abnormal part image blocks and that is configured for generating an image including the abnormal part, and the abnormal part image blocks including a part defect belonging to a same type of part as the part to be inspected.

In some embodiments of this application, the K positive sample images including the normal part are obtained. Then, the K positive sample images are adjusted, to composite the K negative sample images, the positive sample images being sample template images including the normal part. In other words, in some embodiments of this application, rich negative sample images are obtained by using the K positive sample images including the normal part, so that the second feature extraction network obtained by performing training by using the rich negative sample images has good robustness, thereby achieving a technical effect of improving accuracy of a recognition result of an image recognition manner for an industrial part.

In some embodiments, in a solution, the adjusting the K positive sample images, to synthesize the K negative sample images includes one of the following:
S1: Add white noise to the positive sample images, to generate the negative sample images.

In some embodiments, the adding white noise to the positive sample images, to generate the negative sample images may include, but is not limited to: adding Gaussian noise to the positive sample images, to generate the negative sample images.
S2: Obtain a plurality of abnormal part image blocks, the abnormal part image blocks including a part defect belonging to a same type of part as the part to be inspected, and covering the positive sample images with one or at least two of the plurality of abnormal part image blocks, to generate the negative sample images.

After the covering the positive sample images with one or at least two of the plurality of abnormal part image blocks, the method further includes: performing harmonization processing on the positive sample images covered with the abnormal part image block.

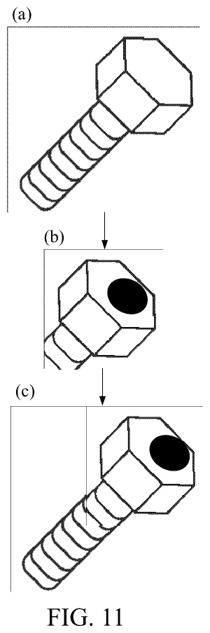

Further, assuming that the positive sample image is an image corresponding to a screw part shown in (a) in FIG. 11, the abnormal part image block may be configured for indicating, but is not limited to, a defective image block corresponding to a position at which a defect often occurs in the screw part shown in (b) in FIG. 11, namely, an image block corresponding to a defective nut. The positive sample image block covered with the abnormal part image block may be, but is not limited to, that shown in (c) in FIG. 11. The image block corresponding to the defective nut covers a nut area of the screw part in the positive sample image.
S3: Input the positive sample images into an abnormal part generation network, to obtain the negative sample images, the abnormal part generation network being a network that is obtained by performing training by using the positive sample images and the abnormal part image blocks and that is configured for generating an image including the abnormal part, and the abnormal part image blocks including a part defect belonging to a same type of part as the part to be inspected.

Before the inputting the positive sample images into an abnormal part generation network, to obtain the negative sample images, the method may include, but is not limited to: obtaining the positive sample image and the abnormal part image block; and continuously training the initialized abnormal part generation network by using the positive sample image and the abnormal part image block, and adjusting a parameter in the abnormal part generation network, until one positive sample image and one abnormal part image block can be inputted into the abnormal part generation network, to obtain a negative sample image belonging to a same type of part as the part to be inspected.

Further, the inputting the positive sample images into an abnormal part generation network, to obtain the negative sample images, the method may include, but is not limited to: inputting the positive sample images into the abnormal part generation network and the abnormal part image blocks into the abnormal part generation network, to obtain the negative sample images.

In some embodiments, the white noise is added to the positive sample images, to generate the negative sample images; the plurality of abnormal part image blocks are obtained, the abnormal part image blocks including the part defect belonging to the same type of part as the part to be inspected, and the positive sample images are covered with the one or at least two of the plurality of abnormal part image blocks, to generate the negative sample images; and the positive sample images are inputted into the abnormal part generation network, to obtain the negative sample images, the abnormal part generation network being the network that is obtained by performing training by using the positive sample images and the abnormal part image blocks and that is configured for generating the image including the abnormal part, and the abnormal part image blocks including the part defect belonging to the same type of part as the part to be inspected. In other words, in some embodiments of this application, rich negative sample images are obtained by using the K positive sample images including the normal part, so that the second feature extraction network obtained by performing training by using the rich negative sample images has good robustness, thereby achieving a technical effect of improving accuracy of a recognition result of an image recognition manner for an industrial part.

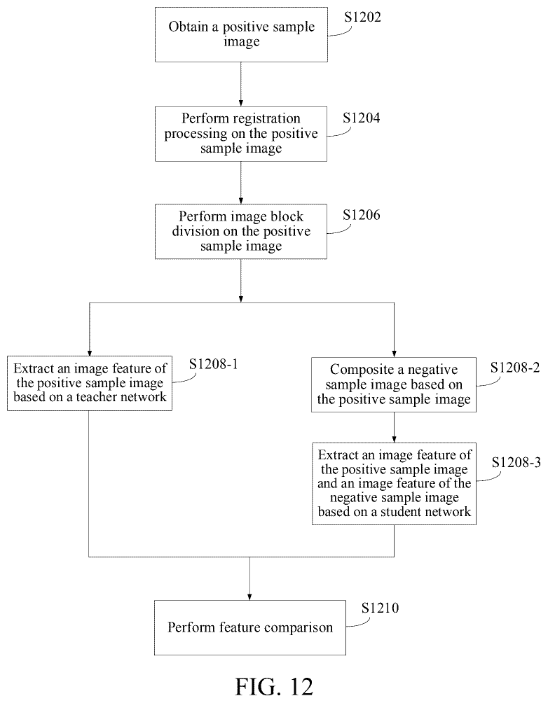

In one embodiment, training operations of the abnormal part recognition network are described by taking the following operations shown in FIG. 12 as an example:
S1202: Obtain a positive sample image.
S1204: Perform registration processing on the positive sample image by using an image registration module.
S1206: Perform image block division on the positive sample image by using an image block division module.
S1208-1: Extract an image feature of the positive sample image based on a teacher network in a learning module.
S1208-2: Composite a negative sample image in a negative sample image block module based on the positive sample image.
S1208-3: Extract an image feature of the positive sample image and an image feature of the negative sample image based on a student network in the learning module.
S1210: Perform, in a feature comparison module, feature comparison between the image feature of the positive sample image extracted based on the teacher network and the image feature of the positive sample image and the image feature of the negative sample image extracted based on the student network.

Specifically, the training is ended when a loss function between the image feature of the positive sample image extracted based on the teacher network and the image feature of the positive sample image extracted based on the student network is less than a predetermined threshold, and a loss function between the image feature of the positive sample image extracted based on the teacher network and the image feature of the negative sample image extracted based on the student network is less than the predetermined threshold. Otherwise, a parameter in the student network is adjusted, and S1202 to S1210 are repeatedly performed, until the loss function between the image feature of the positive sample image extracted based on the teacher network and the image feature of the positive sample image extracted based on the student network is less than the predetermined threshold, and the loss function between the image feature of the positive sample image extracted based on the teacher network and the image feature of the negative sample image extracted based on the student network is less than the predetermined threshold.

The teacher network is configured for indicating the first feature extraction network described above, and the student network is configured for indicating the second feature extraction network described above. In some embodiments of this application, the abnormal part recognition network is trained by using rich sample data, to improve precision of the abnormal part recognition network, thereby achieving a technical effect of improving accuracy of a recognition result of an image recognition manner for an industrial part.

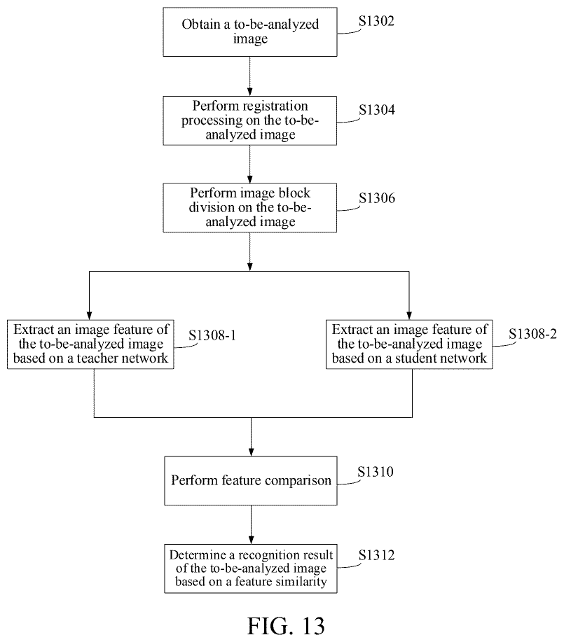

In one embodiment, application operations of the abnormal part recognition network are described by taking the following operations shown in FIG. 13 as an example:
S1302: Obtain an image to be analyzed.
S1304: Perform registration processing on the image to be analyzed by using an image registration module.
S1306: Perform image block division on the image to be analyzed by using an image block division module.
S1308-1: Extract an image feature of the image to be analyzed based on a teacher network in a learning module.
S1308-2: Extract an image feature of the image to be analyzed based on a student network in the learning module.
S1310: Perform, in a feature comparison module, feature comparison between the image feature of the image to be analyzed extracted based on the teacher network and the image feature of the image to be analyzed extracted based on the student network, to obtain a feature similarity.
S1312: Determine a recognition result of the image to be analyzed based on the feature similarity.

Specifically, when a loss function between the image feature of the image to be analyzed extracted based on the teacher network and the image feature of the image to be analyzed extracted based on the student network is less than a predetermined threshold, it is determined that the recognition result is configured for indicating that a part to be inspected is a normal part; or when the loss function between the image feature of the image to be analyzed extracted based on the teacher network and the image feature of the image to be analyzed extracted based on the student network is greater than or equal to the predetermined threshold, it is determined that the recognition result is configured for indicating that the part to be inspected is an abnormal part.

The teacher network is configured for indicating the first feature extraction network described above, and the student network is configured for indicating the second feature extraction network described above. In some embodiments of this application, whether the part to be inspected has an abnormal defect is determined by using a similarity between features, which are respectively extracted from branch networks (namely, the first feature extraction network and the second feature extraction network) in the abnormal part recognition network, of the image to be analyzed corresponding to the part to be inspected. The recognition result of the image to be analyzed is not determined based only on a similarity between an image feature of an image corresponding to the part to be inspected and an image feature of an image corresponding to the normal part. Therefore, a technical problem in an existing technology that accuracy of a recognition result of an image recognition manner for an industrial part is relatively low is solved, thereby achieving a technical effect of improving accuracy of a recognition result of an image recognition manner for an industrial part.

In another embodiment, the modules used in the image recognition method are as follows:

### (1) Image Registration Module:

The image registration module first needs to capture a group of template images. A capture manner is photographing, by using a gold sample (a detected absolutely normal sample), the sample at all image points that need to be detected, and the captured group of images is the template image. An objective of the image registration is to correct an inputted test image, so that a position of the test image can be completely aligned with a template image of a corresponding point, so as to subsequently accurately extract an image block of a specific area. Specifically, positions and angles of the image to be analyzed and the template image are quite different. A transform matrix T between the template image and the image to be analyzed may be calculated by using the image registration module. A registered image to be analyzed may be obtained by applying the transform matrix T. A visual position and angle of the registered image to be analyzed are both aligned with those of the template image. Subsequently, a corresponding image block in the image to be analyzed may be clipped according to a detection coordinate box calibrated in advance in the template image.

In some embodiments, an algorithm of the image registration module is a minimum error iteration method: constructing an error function, defining a to-be-estimated parameter, and optimizing the parameter based on current estimation by using an iteration algorithm to gradually reduce the error function. Specifically, edge detection is performed on the image to be analyzed and the template image, to obtain contour images corresponding to the image to be analyzed and the template image. Then, an NMS operation is performed on the contour images by partition in parallel, to convert the contour images into 2D contour point sets. An average error of the 2D contour point sets between the image to be analyzed and the template image is an error function. The specific function is as follows:

$$F = {\sum }_{k = 1}^{K} \frac{‖ {p}_{k} - {p}_{k}^{t} ‖}{K} \qquad ( 5 )$$

F is the error function, K is a quantity of contour points in the template image, and pₖ is coordinates of a k^{th} contour point in the image to be analyzed, and pₖ^{t} is coordinates of a k^{th} contour point in the template image. After the error function is set, the first operation is to apply a current estimated transformation matrix (which is initially a unit matrix) to a to-be-registered contour point set, the second operation is to establish a matching relationship between the image to be analyzed and a previous contour point set of the template image through nearest neighbor search, the third operation is to remove a matching pair having an excessively large error, the fourth operation is to estimate a transformation matrix through RANSAC, and the first operation is repeated, until the error function converges.

### (2) Image Block Division Module:

One of the objectives of the image block division module is to narrow a single abnormality detection image receptive field. Specifically, many defects are of a relatively small size and a relatively slight extent. Therefore, if an entire image is inputted into an abnormality detection network for detection, because most areas in the image are normal areas, and abnormal areas occupy only a very small part, detection difficulty is very large. However, if the image is divided into blocks first and then detected, the area of the abnormal areas is larger than that of the image blocks, and detection difficulty is reduced. A second objective of the image block division module is to locate a position of an abnormal defect. If an entire image is inputted into an abnormality detection network for detection, even if it can be determined that an image is an abnormal image, it is difficult to locate a position of an abnormal defect. However, if the image is divided into blocks first and then detected, as long as it is determined that an image block is abnormal, it can be determined that the entire image is abnormal, and a position of the image block in the image is the position of the abnormal defect.

In some embodiments, an image may be directly divided into 28×28 image blocks of the same size, but this is not limited thereto. An advantage of this division method is strong universality, and any abnormality detection task may be divided in this way. In addition, division areas may be manually set based on a template image. After being registered based on the template image, an image to be analyzed may be divided according to the manually set division areas, so that the division areas have more significant semantic features.

### (3) Abnormal Image Block Compositing Module:

An objective of the abnormal image block compositing module is to improve robustness of a student network to an abnormal defect. In some embodiments, an abnormal image block may be composited by using, but is not limited to, the following plurality of methods, so as to improve defect diversity of the abnormal image block:
Method 1: Add white noise. Specifically, a composited abnormal image block may be obtained by randomly adding some white noise to a normal image block. A range may be set for a size and a position of noise, and different random white noise is added to simulate defects of various degrees and various sizes.
Method 2: Paste a defective image block. Specifically, some existing defects are picked up by using image matting software, and then randomly pasted into a normal image block. Then, image harmonization processing is performed on the composited image block, to obtain a usable abnormal image block.
Method 3: Generate a defect by using a network. Specifically, a lightweight image processing technology (Inpainting) network is designed, and the Inpainting network is trained by using a normal image of a defective part and the defective part, so that after the normal image of the defective part and the defective part are inputted to the Inpainting network, an obtained output result is a composited abnormal image block with a defect.

### (4) Feature Learning Module:

In some embodiments, network structures and initial parameters of a student network and a teacher network are the same, and a pre-trained ResNet-50 network may be used. In a learning process, the parameter of the teacher network is fixed, and the parameter of the student network is learnable. Specifically, a same normal image block is inputted into the student network and the teacher network, so that output features thereof are as similar as possible. An objective is to make the student network and the teacher network output similar features for input of a same normal image block in a testing phase. In addition, when the normal image block is inputted into the teacher network, an abnormal image block composited by using the normal image block is further inputted into the student network, so that output features thereof are similar as possible. An objective is that in a testing phase, for input of a same abnormal image block, the teacher network may output a feature of the abnormal image block, and the student network may output a feature of the normal image block due to robustness to an abnormal defect. Therefore, the teacher network and the student network may output features with a relatively low similarity.

Further, in some embodiments, a loss function of the feature learning module is a normalized L2 loss function, and ranges from 0 to 1. A larger similarity between two features indicates a smaller loss function.

### (5) Feature Comparison Module:

The feature comparison module is a determining module in a testing phase. For an inputted image to be analyzed, features outputted by a teacher network and a student network of the image to be analyzed are separately calculated, and then an L2 loss between the two features is calculated. If a value of the loss is less than 0.5, it indicates that a similarity between the two features is relatively high, indicating that the image to be analyzed is a normal image. If the value of the loss is greater than 0.5, it indicates that the similarity between the two features is relatively low, indicating that the image to be analyzed is an abnormal image, and further indicating that the image to be analyzed is an abnormal image, and a position of an abnormal defect is a position of an abnormal image block.

For the foregoing method embodiments, for brief description, all method embodiments are described as a series of action combinations. However, a person of ordinary skill in the art needs to note that this application is not limited by the action sequence described. Because in accordance with this application, operations may be performed in other orders or simultaneously. In addition, a person of ordinary skill in the art needs to note that embodiments described in the specification are all preferred embodiments, and the involved action and module are not necessarily required for this application.

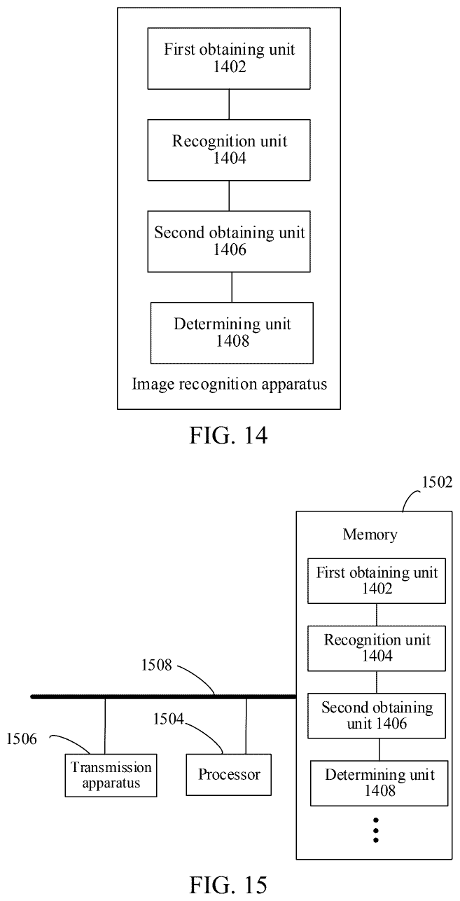

According to another aspect of some embodiments of this application, an image recognition apparatus for implementing the image recognition method is further provided. As shown in FIG. 14, the apparatus includes:
a first obtaining unit 1402, configured to obtain an image to be analyzed obtained by performing image capture on a part to be inspected;
a recognition unit 1404, configured to extract an image feature of the image to be analyzed by using an abnormal part recognition network having a twinned network structure, the image feature including a first image feature extracted from the image to be analyzed by a first feature extraction network in the twinned network structure, and a second image feature extracted from the image to be analyzed by a second feature extraction network in the twinned network structure, the first feature extraction network being obtained by performing training by using a positive sample image, the second feature extraction network being obtained by performing training with the first feature extraction network as a reference network by using a negative sample image, the positive sample image is a sample image that is in a sample image pair and that includes a normal part, and the negative sample image is a sample image that is composited based on the positive sample image and that includes an abnormal part;
a second obtaining unit 1406, configured to obtain a feature similarity between the first image feature and the second image feature; and
a determining unit 1408, configured to determine a recognition result of the image to be analyzed based on the feature similarity, the recognition result indicating whether the part to be inspected in the image to be analyzed is an abnormal part.

In some embodiments, the determining unit includes:
a first determining module, configured to: when the feature similarity is less than or equal to a first threshold, determine that the part to be inspected is the abnormal part, and determine that the recognition result is that the image to be analyzed belongs to a first type of image configured for indicating an abnormal part; and
a second determining module, configured to: when the feature similarity is greater than or equal to a second threshold, determine that the part to be inspected is the normal part, and determine that the recognition result is that the image to be analyzed belongs to a second type of image configured for indicating a normal part, the first threshold being less than the second threshold.

In some embodiments, the apparatus further includes:
a third obtaining unit, configured to obtain a template image corresponding to the part to be inspected, the template image including a reference part belonging to a same type of part as the part to be inspected, and the reference part being a normal part; and
a correction unit, configured to correct a display position of the part to be inspected in the image to be analyzed according to a display position of the reference part in the template image, to obtain a corrected image, the part to be inspected in the corrected image being in display alignment with the reference part in the template image.

In some embodiments, the correction unit includes:
a detection module, configured to perform edge detection processing on the reference part in the template image, to obtain a first object contour image, and perform edge detection processing on the part to be inspected in the image to be analyzed, to obtain a second object contour image;
a conversion module, configured to convert the first object contour image into a first object contour point set, and convert the second object contour image into a second object contour point set;
a third determining unit, configured to determine a correction transformation matrix based on a point correspondence between the first object contour point set and the second object contour point set; and
a correction module, configured to perform position correction on the second object contour point set in the image to be analyzed by using the correction transformation matrix, to obtain a corrected image including a third object contour point set, a display position of each contour point in the third object contour point set in the corrected image respectively corresponding to a display position of each contour point in the first object contour point set in the template image.

Optionally, the third determining module is further configured to: determine a current transformation matrix to be estimated; perform transformation processing on the second object contour point set by using the current transformation matrix, to obtain a reference contour point set; determine a position error between a display position of each contour point in the reference contour point set and a display position of each contour point in the first object contour point set based on a point correspondence between each contour point in the first object contour point set and each contour point in the reference contour point set, to obtain a plurality of point errors; determine a transformation error between the reference contour point set and the first object contour point set by using the plurality of point errors; and determine the current transformation matrix as the correction transformation matrix when the transformation error satisfies an error convergence condition.

In some embodiments, the recognition unit includes:
a division module, configured to perform area division on the image to be analyzed, to obtain N image to be analyzed blocks, N being a positive integer greater than 1; and
an extraction module, configured to perform feature extraction on the N image to be analyzed blocks by using the abnormal part recognition network, to obtain the image feature.

In some embodiments, the division module is further configured to: divide the image to be analyzed according to a preset size, to obtain N image blocks having the same size, and determine the N image blocks as the N image to be analyzed blocks; and clip N key image blocks from the image to be analyzed, the key image block being an image block that is in the image to be analyzed and in which a key object part of the part to be inspected is located, and determine the N key image blocks as the N image to be analyzed blocks.

In some embodiments, the extraction module is further configured to sequentially determine each of the N image to be analyzed blocks as a current image block, and perform the following operations: inputting the current image block into the first feature extraction network, to obtain the first current sub-image feature, and inputting the current image block into the second feature extraction network, to obtain the second current sub-image feature, the first image feature including the first current sub-image feature, and the second image feature including the second current sub-image feature.

In some embodiments, the apparatus further includes:
a fourth obtaining unit, configured to obtain K positive sample images including the normal part and K negative sample images including the abnormal part, to obtain K sample image pairs, the negative sample images being composited by adjusting the positive sample images, and K being a natural number greater than 1; and
a training unit, configured to train the initialized abnormal part recognition network by using the K sample image pairs, until a comparison result between an output feature of the second feature extraction network and an output feature of the first feature extraction network satisfies a convergence condition.

In some embodiments, the training unit is further configured to obtain a current sample image pair from the K sample image pairs, and perform the following operations: inputting a current positive sample image in the current sample image pair into the first feature extraction network, to obtain a current positive sample sub-image feature, and inputting a current negative sample image in the current sample image pair into the second feature extraction network, to obtain a current negative sample sub-image feature; obtaining a next sample image pair as the current sample image pair when a feature similarity between the current negative sample sub-image feature and the current positive sample sub-image feature is less than a third threshold; adding one to a training convergence statistics result when the feature similarity between the current negative sample sub-image feature and the current positive sample sub-image feature is greater than or equal to the third threshold; and determining that the convergence condition is satisfied when the training convergence statistics result reaches a fourth threshold.

In some embodiments, the fourth obtaining unit includes:
an obtaining module, configured to obtain the K positive sample images including the normal part; and
an adjustment module, configured to adjust the K positive sample images, to composite the K negative sample images, the positive sample images being sample template images including the normal part.

In some embodiments, the adjustment module is further configured to: add white noise to the positive sample images, to generate the negative sample images; obtain a plurality of abnormal part image blocks, the abnormal part image blocks including a part defect belonging to a same type of part as the part to be inspected, and cover the positive sample images with one or at least two of the plurality of abnormal part image blocks, to generate the negative sample images; and input the positive sample images into an abnormal part generation network, to obtain the negative sample images, the abnormal part generation network being a network that is obtained by performing training by using the positive sample images and the abnormal part image blocks and that is configured for generating an image including the abnormal part, and the abnormal part image blocks including a part defect belonging to a same type of part as the part to be inspected.

For specific embodiments, refer to some embodiments of the image recognition method. Details are not described herein.

According to another aspect of some embodiments of this application, an electronic device configured to implement the image recognition method is further provided. In some embodiments, an example in which the electronic device is a terminal is used for illustrative description. As shown in FIG. 15, the electronic device includes a memory 1502 and a processor 1504. The memory 1502 has a computer program stored therein, and the processor 1504 is configured to perform operations in any of the foregoing method embodiments by using the computer program.

In some embodiments, the electronic device may be located in at least one of a plurality of network devices of a computer network.

In some embodiments, the processor may be configured to perform the image recognition method described in any one of the foregoing embodiments by using the computer program.

In some embodiments, a person of ordinary skill in the art may understand that the structure shown in FIG. 15 is merely an example, and the electronic device may alternatively be a terminal device such as a smartphone (such as an Android phone or an iOS phone), a tablet computer, a palmtop computer, a mobile internet device (MID), or a PAD. The structure of the foregoing electronic device is not limited in FIG. 15. For example, the electronic device may further include more or less components (for example, a network interface) than those shown in FIG. 15, or has a configuration different from that shown in FIG. 15.

The memory 1502 may be configured to store a software program and a module, such as program instructions/modules corresponding to the image recognition method and apparatus in some embodiments of this application. The processor 1504 runs the software program and the module stored in the memory 1502, to perform various function applications and data processing, that is, implement the image recognition method. The memory 1502 may include a high-speed random memory, and may further include a non-volatile memory, such as one or more magnetic storage apparatuses, a flash memory, or another nonvolatile solid-state memory. In some examples, the memory 1502 may further include a memory remotely disposed relative to the processor 1504, and these remote memories may be connected to the terminal through the network. Examples of the foregoing network include, but are not limited to, the internet, the intranet, a local area network, a mobile communication network, and a combination thereof. The memory 1502 may be specifically configured to, but is not limited to, store an image to be analyzed. In an example, as shown in FIG. 15, the memory 1502 may include, but is not limited to, the first obtaining unit 1402, the recognition unit 1404, the second obtaining unit 1406, and the determining unit 1408 in the image recognition apparatus. In addition, the memory 1502 may further include, but is not limited to, other modules and units in the image recognition apparatus. Details are not described in this example.

In some embodiments, a transmission apparatus 1506 is configured to receive or transmit data through a network. Specific examples of the network may include a wired network and a wireless network. In an example, the transmission apparatus 1506 includes a network interface controller (NIC). The NIC may be connected to another network device and a router by using a network cable, to communicate with the internet or the local area network. In an example, the transmission apparatus 1506 is a radio frequency (RF) module, and is configured to communicate with the internet in a wireless manner.

In addition, the electronic device further includes a connection bus 1508, configured to connect various modules and components in the electronic device.

In other embodiments, the terminal device or the server may be a node in a distributed system. The distributed system may be a blockchain system, and the blockchain system may be a distributed system formed by connecting a plurality of nodes in a form of network communication. A peer to peer network may be formed between the nodes. A computing device in any form, for example, an electronic device such as a server or a terminal, may become a node in the blockchain system by joining in with the peer to peer network.

According to one aspect of this application, a computer program product is provided. The computer program product includes a computer program. The computer program includes program code configured for performing the method. In such an embodiment, the computer program may be downloaded and installed from a network through a communication part, and/or installed from a removable medium. When the computer program is executed by a central processing unit, various functions provided in some embodiments of this application are performed.

According to one aspect of this application, a computer-readable storage medium is provided. A processor of a computer device reads a computer program from the computer-readable storage medium. The processor executes the computer program, to enable the computer device to implement the method.

In some embodiments, the computer-readable storage medium may be configured to store a computer program configured for performing the image recognition method in any one of the foregoing embodiments.

In some embodiments, a person of ordinary skill in the art may understand that all or some of the operations to some embodiments may be by a program instructing relevant hardware of a terminal device. The program may be stored in using a computer-readable storage medium. The storage medium may include a flash disk, a read-only memory (ROM), a random access memory (RAM, magnetic disk, an optical disk, or the like.

When the integrated unit in the foregoing embodiment is implemented in the form of a software function unit and sold or used as an independent product, the integrated unit may be stored in the foregoing computer-readable storage medium. Based on such an understanding, the technical solutions of this application essentially, or the part contributing to the related art, or all or a part of the technical solutions may be implemented in the form of a software product. The computer software product is stored in a storage medium and includes several instructions for instructing a computer device (which may be a personal computer, a server, or a network device) to perform all or some of the operations in the methods described in some embodiments of this application.

In the foregoing embodiments of this application, the descriptions of each embodiment have different focuses. For a part that is not described in detail in an embodiment, refer to the relevant descriptions of other embodiments.

In several embodiments provided in this application, a disclosed client may be implemented in other manners. For example, the described apparatus embodiment is merely an example. For example, the unit division is merely logical function division and may be another division during actual implementation. For example, a plurality of units or components may be merged or integrated into another system, or some features may be ignored or not performed. In addition, the displayed or discussed mutual couplings or direct couplings or communication connections may be implemented by some interfaces; indirect couplings or communication connections between units or modules which may be electric or in other forms.

The units described as separate components may or may not be physically separate, and components displayed as units may or may not be physical units, may be located in one place, or may be distributed on a plurality of network units. Some or all of the units can be selected according to actual needs to achieve the objectives of the solution in the embodiment.

In addition, functional units in some embodiments of this application may be integrated into one processing unit, or each of the units may exist alone physically, or two or more units are integrated into one unit. The integrated unit may be implemented in a form of hardware, or may be implemented in a form of a software functional unit.

The foregoing is merely a preferred implementation of some embodiments of this application. A person of ordinary skill in the art can further make several improvements and refinements without departing from the principle of this application, and the improvements and refinements a shall fall within the protection scope of this application.

What is claimed is:

1. An image recognition method, the method being performed by an electronic device, and comprising:
obtaining an image to be analyzed by performing image capture on a part to be inspected;
extracting an image feature of the image to be analyzed by using an abnormal part recognition network having a twinned network structure, the image feature comprising a first image feature extracted from the image to be analyzed by a first feature extraction network in the twinned network structure, and a second image feature extracted from the image to be analyzed by a second feature extraction network in the twinned network structure, the first feature extraction network being obtained by performing training by using a positive sample image, the second feature extraction network being obtained by performing training with the first feature extraction network as a reference network by using a negative sample image, the positive sample image is a sample image that is in a sample image pair and that comprises a normal part, and the negative sample image is a sample image that is composited based on the positive sample image and that comprises an abnormal part;
obtaining a feature similarity between the first image feature and the second image feature; and
determining a recognition result of the image to be analyzed based on the feature similarity, the recognition result indicating whether the part to be inspected in the image to be analyzed is an abnormal part.

2. The method according to claim 1, wherein the determining a recognition result of the image to be analyzed based on the feature similarity comprises:
when the feature similarity is less than or equal to a first threshold, determining that the part to be inspected is the abnormal part, and determining that the recognition result is that the image to be analyzed belongs to a first type of image configured for indicating an abnormal part; and
when the feature similarity is greater than or equal to a second threshold, determining that the part to be inspected is the normal part, and determining that the recognition result is that the image to be analyzed belongs to a second type of image configured for indicating a normal part,
the first threshold being less than the second threshold.

3. The method according to claim 1, wherein after the obtaining an image to be analyzed by performing image capture on a part to be inspected, the method further comprises:
obtaining a template image corresponding to the part to be inspected, the template image comprising a reference part belonging to a same type of part as the part to be inspected, and the reference part being a normal part; and
correcting a display position of the part to be inspected in the image to be analyzed according to a display position of the reference part in the template image, to obtain a corrected image, the part to be inspected in the corrected image being in display alignment with the reference part in the template image.

4. The method according to claim 3, wherein the correcting a display position of the part to be inspected in the image to be analyzed according to a display position of the reference part in the template image, to obtain a corrected image comprises:
performing edge detection processing on the reference part in the template image, to obtain a first object contour image, and performing edge detection processing on the part to be inspected in the image to be analyzed, to obtain a second object contour image;
converting the first object contour image into a first object contour point set, and converting the second object contour image into a second object contour point set;
determining a correction transformation matrix based on a point correspondence between the first object contour point set and the second object contour point set; and
performing position correction on the second object contour point set in the image to be analyzed by using the correction transformation matrix, to obtain a corrected image comprising a third object contour point set, a display position of each contour point in the third object contour point set in the corrected image respectively corresponding to a display position of each contour point in the first object contour point set in the template image.

5. The method according to claim 4, wherein the determining a correction transformation matrix based on a point correspondence between the first object contour point set and the second object contour point set comprises:
determining a current transformation matrix;
performing transformation processing on the second object contour point set by using the current transformation matrix, to obtain a reference contour point set;
determining a position error between a display position of each contour point in the reference contour point set and a display position of each contour point in the first object contour point set based on a point correspondence between each contour point in the first object contour point set and each contour point in the reference contour point set, to obtain a plurality of point errors;
determining a transformation error between the reference contour point set and the first object contour point set by using the plurality of point errors; and
determining the current transformation matrix as the correction transformation matrix when the transformation error satisfies an error convergence condition.

6. The method according to claim 1, wherein the extracting an image feature of the image to be analyzed by using an abnormal part recognition network having a twinned network structure comprises:
performing area division on the image to be analyzed, to obtain N image to be analyzed blocks, N being a positive integer greater than 1; and
performing feature extraction on the N image to be analyzed blocks by using the abnormal part recognition network, to obtain the image feature.

7. The method according to claim 6, wherein the performing area division on the image to be analyzed, to obtain N image to be analyzed blocks comprises one of the following:
dividing the image to be analyzed according to a preset size, to obtain N image blocks having the same size, and determining the N image blocks as the N image to be analyzed blocks; and
clipping N key image blocks from the image to be analyzed, the key image block being an image block that is in the image to be analyzed and in which a key object part of the part to be inspected is located, and determining the N key image blocks as the N image to be analyzed blocks.

8. The method according to claim 6, wherein the performing feature extraction on the N image to be analyzed blocks by using the abnormal part recognition network, to obtain the image feature comprises:
sequentially determining each of the N image to be analyzed blocks as a current image block, and performing the following operations:
inputting the current image block into the first feature extraction network, to obtain a first current sub-image feature, and inputting the current image block into the second feature extraction network, to obtain a second current sub-image feature, the first image feature comprising the first current sub-image feature, and the second image feature comprising the second current sub-image feature.

9. The method according to claim 1, wherein before the obtaining an image to be analyzed by performing image capture on a part to be inspected, the method further comprises:
obtaining K positive sample images comprising the normal part and K negative sample images comprising the abnormal part, to obtain K sample image pairs, the negative sample images being composited by adjusting the positive sample images, and K being a natural number greater than 1; and
training the initialized abnormal part recognition network by using the K sample image pairs, until a comparison result between an output feature of the second feature extraction network and an output feature of the first feature extraction network satisfies a convergence condition.

10. The method according to claim 9, wherein the training the initialized abnormal part recognition network by using the K sample image pairs, until a comparison result between an output feature of the second feature extraction network and an output feature of the first feature extraction network satisfies a convergence condition comprises:
obtaining a current sample image pair from the K sample image pairs, and performing the following operations: inputting a current positive sample image in the current sample image pair into the first feature extraction network, to obtain a current positive sample sub-image feature, and inputting a current negative sample image in the current sample image pair into the second feature extraction network, to obtain a current negative sample sub-image feature;
obtaining a next sample image pair as the current sample image pair when a feature similarity between the current negative sample sub-image feature and the current positive sample sub-image feature is less than a third threshold;
adding one to a training convergence statistics result when the feature similarity between the current negative sample sub-image feature and the current positive sample sub-image feature is greater than or equal to the third threshold; and
determining that the convergence condition is satisfied when the training convergence statistics result reaches a fourth threshold.

11. The method according to claim 9, wherein the obtaining K positive sample images comprising the normal part and K negative sample images comprising the abnormal part, to obtain K sample image pairs comprises:
obtaining the K positive sample images comprising the normal part; and
adjusting the K positive sample images, to composite the K negative sample images, the positive sample images being sample template images comprising the normal part.

12. The method according to claim 11, wherein the adjusting the K positive sample images, to composite the K negative sample images comprises one of the following:
adding white noise to the positive sample images, to generate the negative sample images;
obtaining a plurality of abnormal part image blocks, the abnormal part image blocks comprising a part defect belonging to a same type of part as the part to be inspected, and covering the positive sample images with one or at least two of the plurality of abnormal part image blocks, to generate the negative sample images; and
inputting the positive sample images into an abnormal part generation network, to obtain the negative sample images, the abnormal part generation network being a network that is obtained by performing training by using the positive sample images and the abnormal part image blocks and that is configured for generating an image comprising the abnormal part, and the abnormal part image blocks comprising a part defect belonging to a same type of part as the part to be inspected.

13. A non-transitory computer-readable storage medium, comprising a program stored therein, the program, when run by a processor, causing the processor to implement an image recognition method comprising:
obtaining an image to be analyzed by performing image capture on a part to be inspected;
extracting an image feature of the image to be analyzed by using an abnormal part recognition network having a twinned network structure, the image feature comprising a first image feature extracted from the image to be analyzed by a first feature extraction network in the twinned network structure, and a second image feature extracted from the image to be analyzed by a second feature extraction network in the twinned network structure, the first feature extraction network being obtained by performing training by using a positive sample image, the second feature extraction network being obtained by performing training with the first feature extraction network as a reference network by using a negative sample image, the positive sample image is a sample image that is in a sample image pair and that comprises a normal part, and the negative sample image is a sample image that is composited based on the positive sample image and that comprises an abnormal part;
obtaining a feature similarity between the first image feature and the second image feature; and
determining a recognition result of the image to be analyzed based on the feature similarity, the recognition result indicating whether the part to be inspected in the image to be analyzed is an abnormal part.

14. The computer-readable storage medium according to claim 13, wherein the determining a recognition result of the image to be analyzed based on the feature similarity comprises:
when the feature similarity is less than or equal to a first threshold, determining that the part to be inspected is the abnormal part, and determining that the recognition result is that the image to be analyzed belongs to a first type of image configured for indicating an abnormal part; and
when the feature similarity is greater than or equal to a second threshold, determining that the part to be inspected is the normal part, and determining that the recognition result is that the image to be analyzed belongs to a second type of image configured for indicating a normal part,
the first threshold being less than the second threshold.

15. The computer-readable storage medium according to claim 13, wherein after the obtaining an image to be analyzed by performing image capture on a part to be inspected, the method further comprises:
obtaining a template image corresponding to the part to be inspected, the template image comprising a reference part belonging to a same type of part as the part to be inspected, and the reference part being a normal part; and
correcting a display position of the part to be inspected in the image to be analyzed according to a display position of the reference part in the template image, to obtain a corrected image, the part to be inspected in the corrected image being in display alignment with the reference part in the template image.

16. The computer-readable storage medium according to claim 15, wherein the correcting a display position of the part to be inspected in the image to be analyzed according to a display position of the reference part in the template image, to obtain a corrected image comprises:
performing edge detection processing on the reference part in the template image, to obtain a first object contour image, and performing edge detection processing on the part to be inspected in the image to be analyzed, to obtain a second object contour image;
converting the first object contour image into a first object contour point set, and converting the second object contour image into a second object contour point set;
determining a correction transformation matrix based on a point correspondence between the first object contour point set and the second object contour point set; and
performing position correction on the second object contour point set in the image to be analyzed by using the correction transformation matrix, to obtain a corrected image comprising a third object contour point set, a display position of each contour point in the third object contour point set in the corrected image respectively corresponding to a display position of each contour point in the first object contour point set in the template image.

16. An electronic device, comprising a memory and a processor, the memory having a computer program stored therein, and the processor being configured to perform an image recognition method comprising:
obtaining an image to be analyzed by performing image capture on a part to be inspected;
extracting an image feature of the image to be analyzed by using an abnormal part recognition network having a twinned network structure, the image feature comprising a first image feature extracted from the image to be analyzed by a first feature extraction network in the twinned network structure, and a second image feature extracted from the image to be analyzed by a second feature extraction network in the twinned network structure, the first feature extraction network being obtained by performing training by using a positive sample image, the second feature extraction network being obtained by performing training with the first feature extraction network as a reference network by using a negative sample image, the positive sample image is a sample image that is in a sample image pair and that comprises a normal part, and the negative sample image is a sample image that is composited based on the positive sample image and that comprises an abnormal part;
obtaining a feature similarity between the first image feature and the second image feature; and
determining a recognition result of the image to be analyzed based on the feature similarity, the recognition result indicating whether the part to be inspected in the image to be analyzed is an abnormal part.

17. The electronic device according to claim 16, wherein the determining a recognition result of the image to be analyzed based on the feature similarity comprises:
when the feature similarity is less than or equal to a first threshold, determining that the part to be inspected is the abnormal part, and determining that the recognition result is that the image to be analyzed belongs to a first type of image configured for indicating an abnormal part; and
when the feature similarity is greater than or equal to a second threshold, determining that the part to be inspected is the normal part, and determining that the recognition result is that the image to be analyzed belongs to a second type of image configured for indicating a normal part,
the first threshold being less than the second threshold.

18. The electronic device according to claim 16, wherein after the obtaining an image to be analyzed by performing image capture on a part to be inspected, the method further comprises:
obtaining a template image corresponding to the part to be inspected, the template image comprising a reference part belonging to a same type of part as the part to be inspected, and the reference part being a normal part; and
correcting a display position of the part to be inspected in the image to be analyzed according to a display position of the reference part in the template image, to obtain a corrected image, the part to be inspected in the corrected image being in display alignment with the reference part in the template image.

19. The electronic device according to claim 18, wherein the correcting a display position of the part to be inspected in the image to be analyzed according to a display position of the reference part in the template image, to obtain a corrected image comprises:
performing edge detection processing on the reference part in the template image, to obtain a first object contour image, and performing edge detection processing on the part to be inspected in the image to be analyzed, to obtain a second object contour image;
converting the first object contour image into a first object contour point set, and converting the second object contour image into a second object contour point set;
determining a correction transformation matrix based on a point correspondence between the first object contour point set and the second object contour point set; and
performing position correction on the second object contour point set in the image to be analyzed by using the correction transformation matrix, to obtain a corrected image comprising a third object contour point set, a display position of each contour point in the third object contour point set in the corrected image respectively corresponding to a display position of each contour point in the first object contour point set in the template image.

20. The electronic device according to claim 19, wherein the determining a correction transformation matrix based on a point correspondence between the first object contour point set and the second object contour point set comprises:
determining a current transformation matrix;
performing transformation processing on the second object contour point set by using the current transformation matrix, to obtain a reference contour point set;
determining a position error between a display position of each contour point in the reference contour point set and a display position of each contour point in the first object contour point set based on a point correspondence between each contour point in the first object contour point set and each contour point in the reference contour point set, to obtain a plurality of point errors;
determining a transformation error between the reference contour point set and the first object contour point set by using the plurality of point errors; and
determining the current transformation matrix as the correction transformation matrix when the transformation error satisfies an error convergence condition.
